(19) United States
(12) Patent Application Publication
(10) Pub. No.: US 2014/0335482 A1
(43) Pub. Date: Nov. 13, 2014

(54) METHODS FOR PROVIDING A PERSONALIZED LIST OF DIETARY NUTRIENTS AND SUPPLEMENTS

(71) Applicant: PRANA ESSENTIALS LTD., Petach Tikva (IL)

(72) Inventors: Zeev Aronis, Petah Tikva (IL); Tomer Loiter, Ramat Hasharon (IL); Yaron Meerfeld, Ramat Gan (IL)

(21) Appl. No.: 14/362,381

(22) PCT Filed: Nov. 29, 2012
(86) PCT No.: PCT/IL2012/050487

§ 371 Date: Jun. 2, 2014

Related U.S. Application Data
(60) Provisional application No. 61/565,819, filed on Dec. 1, 2011.

(51) Int. Cl. G09B 19/00

(52) U.S. Cl. CPC G09B 19/0092
USPC 434/127

(57) ABSTRACT

The present invention provides methods for providing a personalized list of dietary nutraceuticals to an individual, wherein at least one of the nutraceuticals affects the bioavailability of at least one other of the nutraceuticals, the methods including adjusting the amount of the affected nutraceutical based on the influence of the affecting nutraceutical on the bioavailability thereof. The present invention further provides a computerized system including a database and a processor which includes modules configured for providing the list of nutraceuticals according to the invention.

### FIELD OF THE INVENTION

The present invention generally relates to methods for providing a personalized list of dietary nutrients and supplements to an individual.

### BACKGROUND ART

A wide variety of factors influence the nutritional needs of an individual, and no two individuals are the same. Such factors include, for example, the type of work, amount of physical activity, health conditions, dietary habits and other life style choices. Therefore, the generally defined recommended daily values for nutrients or supplements may be too high or too low for a certain individual and, as a result, either not be effective, or even be damaging for the individual.

Methods and systems for assessing individual's needs, designing personalized nutrition and providing personalized nutritional supplements adapted to an individual's needs are available (US 2011/0054928, US 2010/0113892, 2011/0014351, 2008/0275912). However, these methods and systems do not take into consideration the bioavailability of these nutrients and supplements, or quantify how it is affected by the individual's habits and especially by interactions between certain nutrients and supplements when taken together. It is therefore desirable that the daily intake of nutrients and other food supplements not only be tailored according to the individual's needs and habits, but also take into account and make up for interactions between nutrients and supplements, in order to provide a mix of nutrients and supplements which can best benefit the individual.

### SUMMARY OF INVENTION

According to the present invention, there is provided a method for providing a personalized list of dietary nutraceuticals to an individual, wherein at least one of the nutraceuticals affects the bioavailability of at least one other of the nutraceuticals, the method comprising the steps of:

receiving parameters related to the individual (i);

generating a list of nutraceuticals to be taken by the individual comprising nutrients, the list being generated according to the parameters received, wherein each of the nutrients is associated with an individualized daily dose defined at least according to the parameters received (ii);

identifying in the list at least one affected nutraceutical, the bioavailability of which being influenced by at least one affecting nutraceutical comprised in the list, wherein the influence of each of the at least one affecting nutraceutical on the at least one affected nutraceutical is independently represented by a respective interaction value (iii);

adjusting the individualized daily dose associated with at least one of the affected nutraceutical identified in step (iii) according to at least one of said respective interaction values, using a bioavailability adjustment algorithm (iv); and

outputting the list of nutraceuticals with their associated individualized daily doses (v).

According to certain embodiments, the parameters related to the individual received in step (i) comprise parameters selected from age, gender, daily diet, current medical conditions, medical history, medical family history, current medications taken, known allergies, results of blood tests, physical activity type and level, type of work, smoking habits, current and prior intake of supplements and nutrients, pregnancy and breastfeeding status, and whether subject is a vegetarian or a vegan.

According to certain embodiments, the individualized daily dose defined in step (ii) for each one of the nutrients is calculated by subtracting from the daily dose recommended for the nutrient according to Dietary Reference Intake (DRI) tables an estimated daily intake calculated based at least on the daily diet.

According to certain embodiments, the method further comprises prior to step (iii) identifying at least one of the parameters received which is associated with a minimal or maximal daily dose value for at least one of the nutrients comprised in the list, and adjusting the individualized daily dose associated with the at least one nutrient according to a dose defining algorithm, wherein the individualized daily dose of the at least one nutrient is not further adjusted according to step (iv).

According to certain embodiments, the method further comprises identifying prior to step (iii) at least one of the parameters received which is associated with a minimal or maximal daily dose value for at least one dietary supplement, and adding each one of the at least one dietary supplement to the list of nutraceuticals, wherein for each one of the at least one dietary supplement, an individualized daily dose is calculated according to a dose defining algorithm.

According to certain embodiments, the dose defining algorithm for each one of the at least one nutrient or each one of the at least one dietary supplement comprises:

reviewing the minimal or maximal daily dose value associated with each of the at least one parameter identified and the nutrient or supplement (i); and

defining the individualized daily dose for the nutrient or the supplement (ii) as:

the highest of the minimal daily dose values when the minimal or maximal daily dose values comprise only minimal daily dose values (iia);

the lowest of the maximal daily dose values when the minimal or maximal daily dose values comprise only maximal daily dose values (iib); or

the lower between the highest minimal daily dose value and the lowest maximal daily dose value when the minimal or maximal daily dose values comprise at least one minimal daily dose value and at least one maximal daily dose value (iic).

According to certain embodiments, the individualized daily dose for the at least one nutraceutical is adjusted before step (iii) to accommodate for prior intake of the nutraceutical.

According to certain embodiments, the adjusting the individualized daily dose associated with at least one of the affected nutraceutical in step (iv) comprises:

dividing the individualized daily dose by an interaction value associated with the at least one affecting nutraceutical and the affected nutraceutical when the at least one affecting nutraceutical is a sole affecting nutraceutical (i); or

dividing the individualized daily dose by an integrated interaction value calculated from the interaction values associated with each one of the affected nutraceutical and each of the at least one affecting nutraceutical when the at least one affecting nutraceutical comprises more than one affecting nutraceutical (ii).

According to certain embodiments, the at least one affecting nutraceutical comprises more than one affecting nutraceuticals, and:

all of the interaction values are above a predefined neutral interaction value, and the integrated interaction value is the highest of the interaction values (i);

all of the interaction values are below a predefined neutral interaction value, and the integrated interaction value is the lowest of the interaction values (ii); or

some of the interaction values are above and some of the interaction values are below a predefined neutral interaction value, and the integrated interaction value reflects the combination of the highest of the interaction values above the predefined neutral interaction value and the lowest of the interaction values below the predefined neutral interaction value (iii).

According to certain embodiments, the at least one affecting nutraceutical comprises more than one affecting nutraceuticals, and the integrated interaction value is calculated by multiplying all of the interaction values associated with the affected nutraceutical and each of the at least one affecting nutraceutical.

According to certain embodiments, the at least one affecting nutraceutical comprises more than one affecting nutraceuticals, and the integrated interaction value is calculated according to the following steps:

defining for each of the at least one affecting nutraceutical a synergy portion and adjusting the interaction value associated with the affecting nutraceutical and the affected nutraceutical if the individualized daily dose for the affecting nutraceutical is less than the synergy portion, to reflect the ratio between the individualized daily dose and the synergy portion (i);

defining the integrated interaction value as the highest of the interaction values, wherein the interaction values for each of the at least one affecting nutraceutical are above a predefined neutral interaction value (ii);

defining the integrated interaction value as the lowest of the interaction values wherein the interaction values for each of the at least one affecting nutraceutical are below a predefined neutral interaction value (iii); and

offsetting the values above the predefined neutral interaction value with the values below the predefined neutral interaction value to until only interaction values above or only interaction values below the predefined neutral interaction value are left, wherein some of the interaction values are above and some of the interaction values are below the predefined neutral interaction value, and defining the integrated interaction value is as in (ii) or (iii) (iv).

According to certain embodiments, the method further comprises preparing at least one dosage form including the nutraceuticals comprised in the list, each of the nutraceuticals being in an amount based on its associated individualized daily value.

According to certain embodiments, preparing the at least one dosage form comprises the steps of:

calculating a diluted amount for at least one nutraceutical comprised in the list based at least on the individualized daily dose thereof and a predetermined dilution factor (i);

determining the number of the at least one dosage form needed for packaging all nutraceuticals on the list according to dosage form number determining factors (ii);

assigning the nutraceuticals to the at least one dosage form, the number of which determined in step (ii), according to a dosage form assignment algorithm (iii); and

for each one of the at least one dosage form, mixing together nutraceuticals assigned to the dosage form according to their respective diluted amount to thereby prepare the individual dietary nutraceuticals (iv).

According to certain embodiments, calculating a diluted amount for at least one nutraceutical comprised in the list is done by dividing the individualized daily dose of the nutraceutical by a predetermined dilution factor assigned to the nutraceutical.

According to certain embodiments, the dosage form number determining factors are selected from:

the presence of at least one nutraceutical of the list that abolishes the bioavailability of at least one other nutraceutical of the list (a);

the presence of at least one nutraceutical of the list, the individualized daily dose of which is divided into more than one daily intake (b);

the total amount of all nutraceuticals comprised in the list exceeds the capacity of the largest dosage form available (c); and

the presence of nutraceuticals comprised in the list which cannot be mixed together because of technical considerations (d).

According to certain embodiments, at least one of the nutraceuticals comprised in the list is not mixed with other nutraceuticals comprised in the list and is provided as an off-the-shelf item.

According to certain embodiments, the dosage form assignment algorithm comprises assigning nutraceuticals to different dosage forms when one nutraceutical has a negative effect on the bioavailability of a second nutraceutical; and assigning nutraceuticals to the same dosage form when one nutraceutical has a positive effect on the bioavailability of a second nutraceutical.

According to certain embodiments, the diluted amount for each one of the nutraceuticals assigned to each one of the dosage forms is revised based on positive or negative effects on the bioavailability of the nutraceutical by other nutraceuticals assigned to the dosage form.

According to certain embodiments, step (iv) of preparing the at least one dosage form further comprises mixing a pharmaceutically acceptable carrier together with nutraceuticals assigned to at least one of the dosage forms.

According to certain embodiments, the dosage form is selected from a tablet, capsule, pill, softgel, gelcap, sachet, chewing gum, food snack, health bar, or beverage.

The present invention also provides a method for providing a personalized list of dietary nutraceuticals to an individual, wherein at least one of the nutraceuticals affects the bioavailability of at least one other of the nutraceuticals, the method comprising the steps of:

receiving parameters related to the individual (i);

generating a list of nutraceuticals to be taken by the individual comprising nutrients, the list being generated according to the parameters received, wherein each of the nutrients is associated with an individualized daily dose defined at least according to the parameters received (ii);

identifying in the list at least one affected nutraceutical, the bioavailability of which being influenced by at least one affecting nutraceutical comprised in the list, wherein the influence of each of the at least one affecting nutraceutical on the at least one affected nutraceutical is independently represented by a respective interaction value (iii);

adjusting the individualized daily dose associated with at least one of the affected nutraceutical identified in step (iii) according to at least one of the respective interaction values, using a bioavailability adjustment algorithm (iv);

calculating a diluted amount for at least one nutraceutical comprised in the list based at least on the individualized daily dose thereof and a predetermined dilution factor (v);

determining the number of dosage forms needed for packaging all nutraceuticals on the list according to dosage form number determining factors (vi);

assigning the nutraceuticals to the dosage forms according to a dosage form assignment algorithm (vii); and

for each one of the dosage forms, mixing together nutraceuticals assigned to the dosage form according to their respective diluted amount to thereby prepare the individual dietary nutraceuticals (viii).

The present invention further provides a computerized system for providing a personalized list of dietary nutraceuticals to an individual, wherein at least one of the nutraceuticals affects the bioavailability of at least one other of the nutraceuticals, the system comprising:

a parameter receiving module for receiving parameters related to the individual (i);

a nutraceuticals module for generating a list of nutraceuticals to be taken by the individual comprising nutrients, the list being generated according to the parameters received, wherein each of the nutrients is associated with an individualized daily dose defined at least according to the parameters received (ii);

an identifying module for identifying in the list at least one affected nutraceutical, the bioavailability of which being influenced by at least one affecting nutraceutical comprised in the list, wherein the influence of each of the at least one affecting nutraceutical on the at least one affected nutraceutical is independently represented by a respective interaction value (iii);

an adjusting module for adjusting the individualized daily dose associated with at least one of the affected nutraceutical identified in step (iii) according to at least one of the respective interaction values, using a bioavailability adjustment algorithm (iv); and

an outputting module for outputting the list of nutraceuticals with their associated individualized daily doses (v).

According to certain embodiments, the adjusting module is configured for:

dividing the individualized daily dose by an interaction value associated with the at least one affecting nutraceutical and the affected nutraceutical when the at least one affecting nutraceutical is a sole affecting nutraceutical (i); and

dividing the individualized daily dose by an integrated interaction value calculated from the interaction values associated with each one of the affected nutraceutical and each of the at least one affecting nutraceutical when the at least one affecting nutraceutical comprises more than one affecting nutraceutical (ii).

According to certain embodiments, the computerized system further comprises a dosage form module configured for:

calculating a diluted amount for at least one nutraceutical comprised in the list based at least on the individualized daily dose thereof and a predetermined dilution factor (i);

determining the number of dosage forms needed for packaging all nutraceuticals on the list according to dosage form number determining factors (ii); and

assigning the nutraceuticals to the dosage forms according to a dosage form assignment algorithm (iii).

The present invention further provides a system for providing a personalized list of dietary nutraceuticals to an individual, wherein at least one of the nutraceuticals affects the bioavailability of at least one other of the nutraceuticals, the system comprising:

database comprising nutraceuticals and interrelations therebetween, the interrelations include affected and affecting properties of each nutraceutical and its associated interaction values representing the influence of the nutraceutical on an affected nutraceutical and/or the influence of an affecting nutraceutical on the nutraceutical (a); and

processor configured for (b):

receiving parameters related to the individual (i);

generating a list of nutraceuticals to be taken by the individual comprising nutrients, the list being generated according to the parameters received, wherein each of the nutrients is associated with an individualized daily dose defined at least according to the parameters received (ii);

identifying in the list at least one affected nutraceutical, the bioavailability of which being influenced by at least one affecting nutraceutical comprised in the list, wherein the influence of each of the at least one affecting nutraceutical on the at least one affected nutraceutical is independently represented by a respective interaction value (iii);

adjusting the individualized daily dose associated with at least one of the affected nutraceutical identified in step (iii) according to at least one of the respective interaction values, using a bioavailability adjustment algorithm (iv); and

outputting the list of nutraceuticals with their associated individualized daily doses (v).

The computerized system can be any combination of one or more processors, internal memory units, external memory units and communication lines. The computerized system can be grouped together in one geographic location or it can be a distributed system comprising a plurality of computing units in a plurality of locations connected via communication lines (wired and/or unwired communication lines).

The different modules of the computerized system can be implemented in any combination of software and/or hardware and a person skilled in the art would be able to implement the modules of the invention in any desired combination of hardware and/or software.

### BRIEF DESCRIPTION OF DRAWINGS

FIG. 1 shows a flowchart describing in general a method for providing a personalized list of dietary nutraceuticals according to some embodiments of the present invention.

FIG. 2 shows a flowchart describing a method as in FIG. 1 further including adjusting the individualized daily dose of nutraceuticals based on certain parameters having minimum and/or maximal daily intake values for certain nutraceuticals.

FIG. 3 shows a flowchart describing the daily dose defining algorithm for determining the individualized daily dose for nutraceuticals based on minimal and maximal values associated with certain parameters, according to some embodiments of the present invention.

FIG. 4 shows a flowchart describing the bioavailability adjustment algorithm for adjusting the individualized daily dose based on interaction between nutraceuticals, according to some embodiments of the present invention.

FIG. 5 shows a flowchart describing a specific embodiment of a bioavailability adjustment algorithm.

FIG. 6 shows a flowchart describing another specific embodiment of the bioavailability adjustment algorithm.

FIG. 7 shows a flowchart describing assignment of nutraceuticals to dosage forms and preparation of dosage forms, according to some embodiments of the present invention.

FIG. 8 shows a flowchart describing an embodiment of selecting dosage form size and number of dosage forms per day based on the total weight of nutraceuticals to be provided.

FIG. 9 shows a flowchart describing adding nutraceuticals as powder for mixing or as off-the-shelf items, according to some embodiments of the present invention.

FIG. 10 shows a flowchart describing an embodiment of a dosage form assignment algorithm.

FIG. 11 shows a flowchart describing adding back nutraceuticals to dosage forms following extra volume created due to recalculation of daily dose, according to some embodiments of the present invention.

FIG. 12 shows a flowchart describing providing instructions for taking dosage forms at separate times and preparing the composition for the following batch, according to some embodiments of the present invention.

FIG. 13 shows a system for providing a personalized list of dietary nutraceuticals to an individual, according to some embodiments of the present invention.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

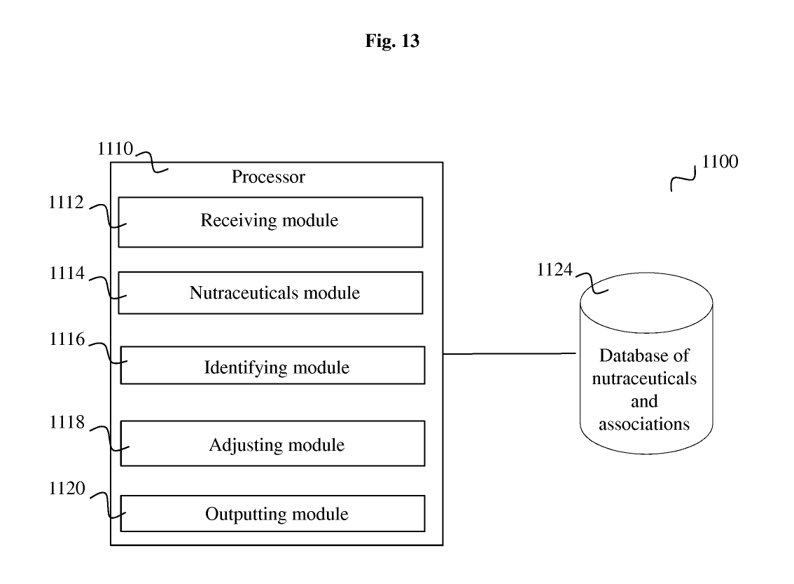

According to some embodiments, the methods of the invention as described hereinbelow are intended to be carried out by a system including a database and a processor, which are described in more detail below, with reference to FIG. 13.

### General Definitions

### Nutraceuticals

Dietary nutrients, termed herein as “nutrients” include micro-nutrients such as vitamins and minerals, for example, vitamin A, vitamin B complex, vitamin C, vitamin D, vitamin E, calcium, iron, magnesium, selenium, zinc, copper, folate, chromium, boron.

Dietary supplements, termed herein as “supplements” are food supplements that are not nutrients, including for example, prebiotics such as dietary fibers, probiotics, omega 3 such as eicosapentaenoic acid (EPA) or docosahexaenoic acid (DHA), herbal extracts, multi vitamin, examples are given in Table 1.

The term “nutraceuticals” is used herein to refer to nutrients and/or supplements as defined above and formulations including them.

The term “prebiotics” as used herein, refers to non-digestible food ingredients that stimulate the growth or the activity of microorganisms of microorganisms of the digestive system, thereby conferring a health benefit to the host. Examples for prebiotics include, but are not limited to, dietary fibers, such as Inulin, Oligofructose, Psylium, Glucomannan.

The term “probiotics” as used herein, refers to live microorganisms which can confer a health benefit to the host. Examples for probiotics include, but are not limited to, lactic acid bacteria, bifidobacteria, yeasts, bacilli.

TABLE 1
List of examples for supplements mixes

| Name of formulation | Content |
|---|---|
| Formulation for dislipidemia | Phytosterols: 1000 mg |
| | Green Tea extract: 300 mg |
| | Omega-3 Fatty acid from fish oil: 600 mg |
| | Coenzyme Q10: 30 mg |
| Formulation for prevention of | Olive leave extract: 600 mg |
| high blood pressure and blood | Pine Bark: 40 mg |
| vessel damage | |
| Formulation for diabetes | Chromium picolinate: 1.8 mg |
| | Cinamon extract: 750 mg |
| | α-lipoic acid: 150 mg |
| Prana-Probiotics (for digestive | 5*10⁹ CFU/capsule |
| track problems) | |
| Prana-Women (for urinary | 5*10⁹ CFU/capsule |
| bladder and genital problems) | Vacciunium Macrocapron: 440 mg |
| Athlete's formulation | Coenzyme Q10 (CoQ10): 100 mg |
| | Conjugated linoleic acid (CLA): 400 mg |
| | Vitis Vinifera extract: 30 mg |
| Formulation for cataract and | Lutein 20%: 50 mg |
| Age-related Macular | Zeaxanthin 5%: 40 mg |
| Degeneration (AMD) | Vitamin E: 30 mg |
| | Vitamin C: 100 mg |
| | Zinc: 8 mg |
| | Copper: 1 mg |
| Formulation for Crohn's | Turmeric root extract—95% (includes 3 |
| disease | curcuminoids): 1000 mg |
| | Piperine extract—95% bioperine: 5 mg |
| Formulation for prostate | Lycopene 520%: 50 mg |
| | Saw palmetto extract: 160 mg |
| | Opuntia ficus indica: 40 mg |
| | Pumpkin Seed: 100 mg |
| | Uritica Diodica: 40 mg |
| | Pygeum Africanum: 40 mg |
| Formulation for subjects not | Omega-3 fatty acid from fish oil: 600 mg |
| consuming at least two | |
| portions of fish per week | |

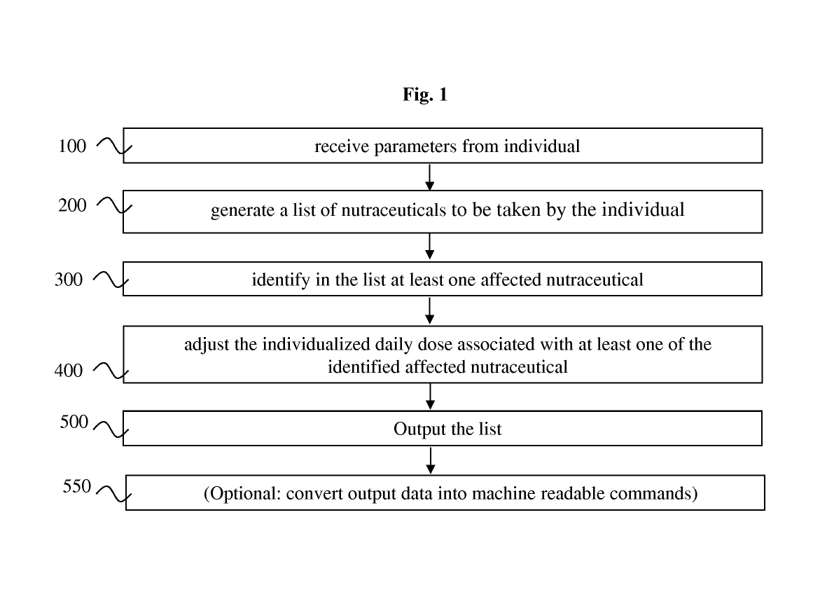

The present invention provides methods for providing a personalized list of dietary nutraceuticals to an individual, provided that at least one of the nutraceuticals affects the bioavailability of at least one other of the nutraceuticals, as outlined in general in FIG. 1, including the steps described below.

As shown in FIG. 1, parameters are received from an individual (100).

According to certain embodiments of the present invention, various parameters, e.g., age, gender and daily diet, are needed in order to determine the identity and amount of nutraceuticals an individual needs.

According to certain embodiments, the parameters related to the individual received in step (i) comprise parameters selected from age, gender, daily diet, current medical conditions, medical history, medical family history, current medications taken, known allergies, results of blood tests, physical activity type and level, type of work, smoking habits, current and prior intake of supplements and nutrients, pregnancy and breastfeeding status, and whether subject is a vegetarian or a vegan.

In some embodiments, parameters such as name, height, weight, address family status, family medical history, current medications taken, etc. can be retrieved for reasons such as statistics, communication or follow up, or for reasons related to additional services provided, such as dietary or other consultation.

Current medical conditions provided by an individual include, for example, type I diabetes, type II diabetes, kidney disease, high blood pressure, coronary heart disease/heart attacks, clinical depression, cancer, e.g., colon cancer, operated on gastric cancer or another kind of cancer, ongoing chemotherapy, celiac, thyroid related conditions, hyperlipidemia, heartburn, diarrhea, constipation, migranes, urinary track infections, candida, inflammatory bowel diseases such as Crohn's disease/colitis, gastric ulcers, enlarged prostate gland, ophthalmic diseases including cataract, problems swallowing, reflux disease, diaphragmatic hernia, cirrhosis, lysosomal storage diseases e.g., Tay Sachs and Gaucher's disease, chronic or frequent colds, cystic fibrosis.

Some medical conditions can have more than one status and the status can influence which nutraceutical is provided to the affected individual. For example, a medical condition which is an inflammatory bowel disease can have three statuses—active disease, within a month following active disease or in remission. According to some embodiments, in case of an active disease, the patient is provided with the appropriate nutraceuticals for the condition, including proper herbal extracts or probiotics, accompanied by maximum recommended levels according to dietary reference index (DRI) tables of some or all nutrients, in the case of remission, the patient is provided with personalized nutraceuticals disregarding the condition, and in the case of a recent active disease (within the previous month), the patient is provided with the appropriate nutraceuticals for the condition for a certain amount of time, for example, for a single month or two, and afterwards with personalized nutraceuticals if the condition changes to the remission phase.

In some embodiments, certain nutraceuticals can be useful in treating more than one condition. For example, probiotics can be useful in treating gastrointestinal conditions, such as colitis but also for treating diabetes (e.g. Lactobaclilus acidophilus combined with Bifidobacterium bifidum).

Allergies and sensitivities include, for example, lactose intolerance, sensitivity to tomatoes, sensitivity to tomato sauce and ketchup, peanut allergy, wheat allergy, gluten sensitivity, milk allergy, egg-white allergy, monosodium glutamate allergy, soy allergy, and sensitivity to fish products.

Prior operations include for example, digestive track operations such as gastric surgery, small intestine surgery, colon surgery, or gall bladder removal, heart operations and catheterization, fractures such as of the arm/ribs/pelvis/femur/spine, which occurred when the subject was over 50 years old (regardless of age at the time of information retrieval) or which occurred when the subject was under 50 years old but in the three years prior to information retrieval, or any other fracture which occurred during the past year.

Family history includes diseases such as, for example, type II diabetes, high blood pressure, heart diseases, colon cancer.

Medications taken by the subject include, for example, statins, treatments for diabetes (not including insulin), insulin, high blood pressure medicine, anti-coagulants, thyroid gland medication, laxatives, antacids, chemotherapeutics, chronically taken antibiotics, monoamine oxidase, serotonin reuptake inhibitors, or any other medications which are retrieved from the individual.

Work type is selected, for example, from the professions listed in Table 2. The individual indicates the weekly hours of working.

TABLE 2
caloric values for sample professions

| | Kilocalories/hour/ | Kilocalories/hour/ |
|---|---|---|
| Type of work | kilogram for women | kilogram for men |
| Security | 2.20 | 2.90 |
| Art and creation | 2.20 | 2.90 |
| Health and medicine | 2.20 | 2.90 |
| Retiree | 1.70 | 1.80 |
| Upper management | 1.70 | 1.80 |
| Education and teaching | 1.70 | 1.80 |
| Unemployed | 1.70 | 1.80 |
| Commerce and retail | 1.70 | 1.80 |
| Driving and transportation | 2.20 | 2.90 |
| Student | 1.70 | 1.80 |
| Self employed | 1.70 | 1.80 |
| Industry—office work | 1.70 | 1.80 |
| Industry—physical work | 3.50 | 5.70 |

Physical exercise is selected, for example, from Table 3. In some embodiments, the individual indicates the frequency and duration of physical exercise.

TABLE 3
caloric values for sample physical exercise.

| Type of exercise | Kilocalories/hour/kilogram |
|---|---|
| Cleaning and house maintenance | 3.6 |
| Stretching/yoga | 2.6 |
| Gardening | 4.2 |
| Lawn mowing | 4.8 |
| Weight lifting (light-medium) | 3.2 |
| Weight lifting (heavy) | 6.3 |
| Gymnastics—back exercise | 3.7 |
| Gymnastics such as jumping jacks | 8.4 |
| Gymnastics such as pushups and crunches | 8.4 |
| Dancing | 4.8 |
| Slow walking (≦3.6 km/hour) | 2.6 |
| Medium pace walking (≦6 km/hour) | 4 |
| Fast walking | 6 |
| Jogging | 7.2 |
| light running (≦9 km/hour) | 9.5 |
| Medium pace running (≦12 km/hour) | 12 |
| Fast pace running (≦14.4 km/hour) | 15 |
| Very fast running | 18 |
| Low grade aerobic exercise | 5.3 |
| High grade aerobic exercise | 7.4 |
| Aerobic exercise - 15-20 cm high steps | 8.9 |
| Aerobic exercise - 25-30 cm high steps | 10.5 |
| Bicycles—light (≦18 km/hour) | 6.3 |
| Bicycles—medium (≦21 km/hour) | 8.3 |
| Bicycles—difficult (≦27 km/hour) | 10.6 |
| Bicycles—very difficult (≦33 km/hour) | 12.8 |
| Bicycles—competitive | 16.8 |
| Spinning (very light, W50) | 3.2 |
| Spinning (light, W100) | 14.5 |
| Spinning (medium, W150) | 7.4 |
| Spinning (difficult, W200) | 11 |
| Spinning (very difficult, W250) | 13.3 |
| Rowing (lignt, W50) | 3.7 |
| Rowing (medium, W100) | 7.4 |
| Rowing (difficult, W150) | 8.9 |
| Rowing (lignt, W200) | 12.6 |
| Swimming—free style, slow-medium | 7.4 |
| Swimming—free style, fast | 10.5 |
| Swimming—back stroke | 7.4 |
| Swimming—crawl | 8.4 |
| Crawl—butterfly | 11.6 |
| Stroll | 3.2 |
| Stoll with backpack | 7.4 |
| Basketball | 8.4 |
| Football/soccer | 7.4 |
| Jump rope—slow | 8.4 |
| Jump rope—medium | 10.5 |
| Jump rope—fast | 12.6 |
| Martial arts | 10.5 |
| Tennis—singles | 8.4 |
| Tennis—couples | 6.3 |
| Running on treadmill—4.8 km/h, slope—0% | 3.5 |
| Running on treadmill—4.8 km/h, slope—2% | 3.9 |
| Running on treadmill—4.8 km/h, slope—4% | 4.3 |
| Running on treadmill—4.8 km/h, slope—6% | 4.7 |
| Running on treadmill—6.5 km/h, slope—0% | 5.3 |
| Running on treadmill—6.5 km/h, slope—2% | 5.9 |
| Running on treadmill—6.5 km/h, slope—4% | 6.5 |
| Running on treadmill—6.5 km/h, slope—6% | 7 |
| Running on treadmill—9.6 km/h, slope—0% | 10.5 |
| Running on treadmill—9.6 km/h, slope—2% | 11.6 |
| Running on treadmill—9.6 km/h, slope—4% | 12.4 |
| Running on treadmill—9.6 km/h, slope—6% | 13.3 |
| Running on treadmill—11.3 km/h, slope—0% | 12.1 |
| Running on treadmill—11.3 km/h, slope—2% | 13.3 |
| Running on treadmill—11.3 km/h, slope—4% | 14.4 |
| Running on treadmill—11.3 km/h, slope—6% | 15.4 |
| Running on treadmill—12.9 km/h, slope—0% | 14.2 |
| Running on treadmill—12.9 km/h, slope—2% | 15.1 |
| Running on treadmill—12.9 km/h, slope—4% | 16.3 |
| Running on treadmill—12.9 km/h, slope—6% | 17.4 |
| Wind surfing | 3.2 |
| Roller blades/skates | 13.1 |

km/h—kilometers per hour;
w—watts;

In some embodiments, physical activities can be associated with values indicating whether they are classified as aerobic, anaerobic or as intermediate activities, and to what level, for example, light, medium intense, highly intense.

According to some embodiments, an individual can be defined as a “sport client”, according to a predetermined level and type of physical activity they report.

According to certain embodiments, additional types of information are received from the individual, for example, whether or not eating deep-sea fish, which can be used to recalculate the amount of certain supplements, such as omega-3.

According to some embodiments, certain parameters can be used to indicate that an individual should not be treated by providing nutraceuticals according to the present invention. Such parameters include, for example, pregnancy, age ≦18, cirrhosis, kidney disease, problem swallowing, creatinine higher than a predefined maximal value, urea higher than a predefined maximal value, potassium higher than a predefined maximal value or lower than a predefined minimal value, and cystic fibrosis. Further, for certain parameters approval by a physician may be needed for treating an individual with the nutraceuticals of the present invention.

Parameters can be received by any suitable method, manual or automatic.

In some embodiments, the parameters are received directly from the individual by entering them into a graphic user interface (GUI) which is part of the system described below. In some embodiments, the parameters are received by a professional interviewing the individual and entering the parameters. In some embodiments, the parameters are received directly from another server, software, database or system e.g. a database of clinical data in a health care organization or a database of physical activities in a sports club, etc.

After receiving parameters from an individual, a list of nutraceuticals to be taken by the individual is generated according to the parameters received, each nutraceutical being associated with an individualized daily dose which is defined based on parameters received as explained in more detail below (200).

According to some embodiments, the list of nutraceuticals is generated by considering known associations between parameters such as, for example, medical conditions or physical activity, and nutrients or supplements which are known or thought to be needed or can otherwise be helpful in such cases, as shown, for example, in Table 1.

The information regarding associations between parameters and nutraceuticals, i.e., nutrients or supplements, can be provided in tables as part of the database described below, or through direct access to the internet, or by direct input of data, or by any other method.

According to some embodiments, such information can be updated periodically or continuously.

Calculating the Individualized Daily Dose

In some embodiments, the list of nutraceuticals to be taken by the individual is defined based on the individual's needs as reflected in parameters received. The list includes at least nutrients.

For each nutrient on the list, a recommended daily dose is defined. Preferably, the recommended daily dose is defined based on minimal or maximal daily values from publicly available DRI (Dietary Reference Intake) tables, (examples for DRI values are provided in Tables 4A and 4B), and on at least the gender and age group to which the individual belongs.

In some embodiments, parameters, e.g. breastfeeding, affect the minimal and maximal daily values from DRI tables.

In certain embodiments, a separate set of predetermined DRI values, which may or may not differ from the DRI values described above and used for the general population, is used for an individuals defined as a “sport client”, based on special dietary requirement associated with the physical activity.

In certain embodiments, the recommended daily dose can be higher than the minimal daily recommendation, but not higher than the maximal upper level, for example in cases where blood tests' results indicate a deficiency in specific vitamins or minerals. It is appreciated that age groups can be defined in various ways and further age groups can be added to accommodate for different populations.

TABLE 4A
minimal (Min) and maximal (Max) DRI values for women

| Nutrient | | Age | | | | |
|---|---|---|---|---|---|---|
| [units] | | 19-30 | 31-50 | 51-70 | >70 | Nursing |
| Calcium | Min | 1000 | 1000 | 1200 | 1200 | 1100 |
| [mg/d] | Max | 2500 | 2500 | 2000 | 2000 | 2500 |
| Iron | Min | 18 | 18 | 8 | 8 | 9 |
| [mg/d] | Max | 45 | 45 | 45 | 45 | 45 |
| Magnesium | Min | 100 | 100 | 100 | 100 | 100 |
| [mg/d] | Max | 350 | 350 | 350 | 350 | 350 |
| Selenium | Min | 55 | 55 | 55 | 55 | 70 |
| [μg/d] | Max | 400 | 400 | 400 | 400 | 400 |
| Zinc | Min | 8 | 8 | 8 | 8 | 12 |
| [mg/d] | Max | 40 | 40 | 40 | 40 | 40 |
| Copper | Min | 900 | 900 | 900 | 900 | 1300 |
| [μg/d] | Max | 10000 | 10000 | 10000 | 10000 | 10000 |
| Thiamin | Min | 1.1 | 1.1 | 1.1 | 1.1 | 1.4 |
| [mg/d] | Max | — | — | — | — | — |
| Riboflavin | Min | 1.1 | 1.1 | 1.1 | 1.1 | 1.6 |
| [mg/d] | Max | — | — | — | — | — |
| Niacin | Min | 14 | 14 | 14 | 14 | 17 |
| [mg/d] | Max | 35 | 35 | 35 | 35 | 35 |
| Folate | Min | 400 | 400 | 400 | 400 | 500 |
| [μg/d] | Max | 1000 | 1000 | 1000 | 1000 | 1000 |
| Vitamin A | Min | 700 | 700 | 700 | 700 | 1300 |
| [μg/d] | Max | 3000 | 3000 | 3000 | 3000 | 3000 |
| Vitamin E | Min | 15 | 15 | 15 | 15 | 19 |
| [mg/d] | Max | 1000 | 1000 | 1000 | 1000 | 1000 |
| Vitamin C | Min | 75 | 75 | 75 | 75 | 120 |
| [mg/d] | Max | 2000 | 2000 | 2000 | 2000 | 2000 |
| Vitamin B6 | Min | 1.3 | 1.3 | 1.5 | 1.5 | 2 |
| [mg/d] | Max | 100 | 100 | 100 | 100 | 100 |
| Vitamin B12 | Min | 2.4 | 2.4 | 2.4 | 2.4 | 2.8 |
| [μg/d] | Max | — | — | — | — | — |
| Chromium | Min | 25 | 25 | 20 | 20 | 45 |
| [μg/d] | Max | — | — | — | — | — |
| Vitamin D | Min | 15 | 15 | 15 | 20 | 15 |
| [μg/d] | Max | 100 | 100 | 100 | 100 | 100 |
| Boron | Min | 1 | 1 | 1 | 1 | 1 |
| [mg/d] | Max | 20 | 20 | 20 | 20 | 20 |

TABLE 4B
minimal (Min) and maximal (Max) DRI values for men

| Nutrient | | Age | | | |
|---|---|---|---|---|---|
| [units] | | 19-30 | 31-50 | 51-70 | >70 |
| Calcium | Min | 1000 | 1000 | 1000 | 1200 |
| [mg/d] | Max | 2500 | 2500 | 2000 | 2000 |
| Iron | Min | 8 | 8 | 8 | 8 |
| [mg/d] | Max | 45 | 45 | 45 | 45 |
| Magnesium | Min | 100 | 100 | 100 | 100 |
| [mg/d] | Max | 350 | 350 | 350 | 350 |
| Selenium | Min | 55 | 55 | 55 | 55 |
| [μg/d] | Max | 400 | 400 | 400 | 400 |
| Zinc | Min | 11 | 11 | 11 | 11 |
| [mg/d] | Max | 40 | 40 | 40 | 40 |
| Copper | Min | 900 | 900 | 900 | 900 |
| [μg/d] | Max | 10000 | 10000 | 10000 | 10000 |
| Thiamin | Min | 1.2 | 1.2 | 1.2 | 1.2 |
| [mg/d] | Max | — | — | — | — |
| Riboflavin | Min | 1.3 | 1.3 | 1.3 | 1.3 |
| [mg/d] | Max | — | — | — | — |
| Niacin | Min | 16 | 16 | 16 | 16 |
| [mg/d] | Max | 35 | 35 | 35 | 35 |
| Folate | Min | 400 | 400 | 400 | 400 |
| [μg/d] | Max | 1000 | 1000 | 1000 | 1000 |
| Vitamin A | Min | 900 | 900 | 900 | 900 |
| [μg/d] | Max | 3000 | 3000 | 3000 | 3000 |
| Vitamin E | Min | 15 | 15 | 15 | 15 |
| [mg/d] | Max | 1000 | 1000 | 1000 | 1000 |
| Vitamin C | Min | 90 | 90 | 90 | 90 |
| [mg/d] | Max | 2000 | 2000 | 2000 | 2000 |
| Vitamin B6 | Min | 1.3 | 1.3 | 1.7 | 1.7 |
| [mg/d] | Max | 100 | 100 | 100 | 100 |
| Vitamin B12 | Min | 2.4 | 2.4 | 2.4 | 2.4 |
| [μg/d] | Max | — | — | — | — |
| Chromium | Min | 35 | 35 | 30 | 30 |
| [μg/d] | Max | — | — | — | — |
| Vitamin D | Min | 15 | 15 | 15 | 20 |
| [μg/d] | Max | 100 | 100 | 100 | 100 |
| Boron | Min | 1 | 1 | 1 | 1 |
| [mg/d] | Max | 20 | 20 | 20 | 20 |

μg/d— microgram per day;
mg/d—milligram per day;

Parameters related to blood work results can influence the individualized daily dose. For example, a deficiency in a certain nutrient, which is discovered in a blood test, indicates a need for providing this nutrient to an individual.

According to certain embodiments, as seen for example in Table 5, certain blood tests have more than a single minimal or maximal value. For all blood tests, results between the first minimum and first maximum indicate no medical condition; results higher than the first maximum indicate a first medical condition; and results lower than the first minimum indicate a second medical condition. According to more specific embodiments, for blood tests wherein a second minimum or second maximum exists, results higher than the second maximum or lower than the second minimum indicate further medical conditions, e.g., a result higher than the second maximum indicates a third medical condition and a result lower than the second minimum indicates a fourth medical condition.

TABLE 5
example for blood work data

| Test | Max-2 | Max-1 | Min-1 | Min-2 | Units |
|---|---|---|---|---|---|
| Cholesterol | 230 | 200 | | | mg/dl |
| LDL | 160 | 130 | | | mg/dl |
| HDL | | | 35 | | mg/dl |
| Triglycerides | 200 | 170 | | | mg/dl |
| Vitamin B12 | | | 300 | 157 | pg/ml |
| Folic Acid | | | 7 | 2.7 | ng/ml |
| Vitamin D | | | 30 | | ng/ml |
| Calcium serum | | 10.4 | 8.4 | | mg/dl |
| Creatinine serum | | 1.3 | | | mg/dl |
| BUN Urea | | 21 | | | mg/dl |
| TSH | | 4.94 | | | μiu/dl |
| T4 | | | 9 | | Pmol/l |
| T3 | | | 2.6 | | Pmol/l |
| Magnesium | | 2.7 | 1.8 | | mg/dl |
| Zinc | | 120 | 70 | | μg/dl |
| Iron | | 170 | 60 | 50 | mg/dl |
| Hb(m) | | 17.5 | 13.5 | | g/dl |
| Hb(w) | | 16 | 12 | | g/dl |
| Transferrin | | 380 | 200 | | mg/dl |
| Ferritin | | 275 | 21.8 | | ng/ml |
| RBC | | 6 | 4.3 | | m/μl |
| Hb A1C | | 6.5 | | | % |
| Albumin | | | 3.5 | | g/dl |
| Potassium | | 5.3 | 3.5 | | mmol/l |
| Uric Acid (m) | | 8.2 | | | mg/dl |
| Uric Acid (w) | | 6.3 | | | mg/dl |

g—gram;
mg—milligrams;
ng—nanogram;
pg—picogram;
1—liter ;
dl—deciliter;
ml—milliliter;
μl—microliter;
mmol—millimole;
pmole—picomole;
μiu—micro international units;
m—million;
Max-1 and Max-2—maximal values;
Min-1 and Min-2—minimal values (see text for explanation);
Hb—Hemoglobin;
LDL—low density lipoprotein;
BUN—blood urea nitrogen;
HDL—high density lipoprotein;
(m) indicates a range of values for men,
(w) indicates a range of values for women (only for Uric Acid and Hemoglobin).

According to certain embodiments, an individual with a medical condition indicated by a blood test result lower than the second minimum (the fourth medical condition described above) is provided with a certain nutraceutical at an increased dose, e.g., a double dose, relative to the dose in which the same nutraceutical is provided to an individual with a medical condition indicated by a result between the first and the second minima.

According to further specific embodiments, an individual with a medical condition indicated by a result higher than the second maximum (the third medical condition described above) is provided with a certain nutraceutical at an increased dose, e.g., a double dose, relative to the dose in which the same nutraceutical is provided to an individual with a medical condition indicated by a result between the first and the second maxima. For example, an individual with a blood test showing a value between 130 and 160 milligram/deciliter (mg/dL) LDL (low density lipoprotein) is provided with one tablet or phytosterols, while an individual with an LDL value above 160 mg/dL is provided with two tablets of phytosterols.

According to alternative embodiments, an individual having a third medical condition as described above is provided the same dose of nutraceuticals as an individual having the first medical condition as described above.

According to additional alternative embodiments, an individual having a fourth medical condition as described above is provided the same dose of nutraceuticals as an individual having the second medical condition as described above.

Parameters including information such as work type and physical exercise can be used to determine the needs of an individual, who needs certain supplements because of being engaged in intense physical activity.

Parameters including information regarding allergies or sensitivities are useful since an individual suffering from certain medical conditions or from allergies or sensitivities should not be provided with certain nutraceuticals. Similarly, an individual who has a certain life style, such as being a vegetarian or a vegan should not receive certain nutraceuticals, as explained in more detail below.

Parameters related to smoking habits are also useful information in that smoking can affect the absorption of certain nutraceuticals and their amount should therefore be increased if given to an individual who is smoking.

Daily Intake

In order to evaluate the needs of the individual, an estimated daily intake of nutrients is also calculated based at least on the nutrient intake from the individual's daily diet. The estimated daily intake for each nutrient is calculated from the daily diet for all food products, based on the amounts of the nutrient in the food product. This amount is calculated, for example, by multiplying the amount of nutrient per 100 grams of food product by the amount in grams consumed divided by 100, and adding the results for all food products consumed on the same day.

For each nutrient, the gap between the recommended daily dose and the estimated daily intake is calculated and termed herein an “individualized daily dose”. If the estimated daily intake is more than the recommended daily dose, then the individualized daily dose is preferably rounded to 0.

Thus, according to certain embodiments, the individualized daily dose defined for each one of the nutrients is calculated by subtracting from the daily dose recommended for the nutrient according to Dietary Reference Intake (DRI) tables an estimated daily intake calculated based at least on the daily diet.

Certain nutraceuticals are provided to replenish gaps between the daily diet and the recommended daily dose based on DRI values (first dose type), or as a result of a medical condition (second dose type). According to certain embodiments, the first dose type is different from the second dose type. For example, vitamin B complex provided to replenish a gap contains different amounts of the individual nutrients in the complex (see Table 2, “norma” complex) from the amounts of nutrients in the vitamin B complex provided as a result of a medical condition (see Table 3, “extra” complex), such as vitamin B12 deficiency in the blood.

In some embodiments, one of the nutrients to be included is not a single nutrient but a complex including several nutrients, for example, vitamin B complex (see Table 6). For some of the nutrients included in the complex the estimated daily intake can be evaluated based on the daily diet, and for others the estimated daily intake cannot be evaluated, for example in the case of vitamin B complex, for biotin and pentatonic acid. Individualized daily dose values are calculated for all nutrients for which daily intake is available and the highest value of individualized daily dose normalized by dividing by the recommended daily dose is used in order to determine the individualized daily dose for the complex.

TABLE 6
Vitamin B complex formulations

| | Dosage for | Dosage for |
|---|---|---|
| | “norma” complex | “extra” complex |
| Nutrient | (milligrams) | (milligrams) |
| Vitamin B1 (Thiamin) | 1.829 | 21.951 |
| Vitamin B2 (riboflavin) | 1.7 | 10 |
| Vitamin B3 (Niacin) | 20 | 50 |
| Vitamin B6 | 2 | 5 |
| Vitamin B12 | 2 | 10 |
| Vitamin B5 (pentatonic acid) | 7 | 10 |
| Vitamin B7 (biotin) | 0.556 | 0.111 |

In certain embodiments, some nutrients e.g. Boron and magnesium, cannot be evaluated based on the daily diet and are therefore treated as if they are not included in the daily diet. As a result, the gap value, or the individualized daily dose, is equal to the recommended daily dose for such nutrients.

In some embodiments, a parameter indicating current nutrients intake that is not from the daily diet, in case the individual is already taking nutrients, can also be used to more accurately calculate estimated daily intake.

According to some certain embodiments, any nutraceutical already taken by the individual according to a prescription by a physician will not be included in the list of nutraceuticals to be taken by the individual. According to other embodiments, instructions will be provided together with the nutraceuticals of the present invention, indicating that the nutraceutical already taken by the individual should be taken separately from the nutraceuticals of the present invention.

According to certain embodiments, as described in more detail below, parameters indicating prior intake of nutrients or supplements can be used to adjust the individualized daily dose so as not to exceed the total amount of a nutraceutical meant for taking for a limited amount of time, for example, to replenish a deficiency.

Entering the Daily Diet

The daily diet for an individual can be entered by using various methods. According to certain embodiments the daily diet is entered by entering a representative daily menu or several representative daily menus. According to this method, the amounts of nutrients are calculated for each menu and then averaged for each nutrient over the number of menus entered.

Alternatively, the daily diet is entered by oral questioning regarding dietary habits and then assembly of a daily diet by the dietician. According to this method, food products consumed during one day are entered into the system, together with consumed amounts. The amounts can be daily amounts or a daily average, for example, of weekly consumption.

According to a certain embodiment, nutrients from the daily diet are not fully absorbed and therefore the estimated daily intake of a nutrient is corrected to reflect the relative amount absorbed out of the amount consumed by multiplying the estimated daily intake calculated from the daily diet by a predetermined value reflecting the fraction of the amount absorbed out of the amount consumed.

According to other embodiments, some nutraceuticals are associated with a value defining a substitute of that nutraceutical, in case the nutraceutical cannot be given, e.g., because it is not in stock or because the subject is allergic to it. If a substitute exists, the nutraceutical is further associated with a value which indicates the exchange factor (i.e. how much of the substitute is needed to replace one weight unit of the nutraceutical) and another value which indicates whether a substitute for this nutraceutical is currently needed. For example, Lutein supplement is not in stock and therefore the flag indicating that a substitute is needed is on. Lycopene is defined as a substitute for Lutein, and the exchange factor is 0.07. As a result, if 20 milligrams of Lutein are needed per tablet, 1.4 milligrams (20*0.07) of Lycopene are used instead. If, because of a medical condition, there is also a need for adding 0.3 milligrams of Lycopene, the amounts will be added, and the tablet will include 1.7 milligrams of Lycopene.

Next, at least one affected nutraceutical is identified in the list, the bioavailability of which is influenced by at least one affecting nutraceutical comprised in the list, wherein the influence of the affecting nutraceutical on the affected nutraceutical is represented by an interaction value (300).

Some nutraceuticals have an effect on the bioavailability of other nutraceuticals, for example, by increasing or decreasing the absorption of the other nutraceuticals, as described in more detail below.

Bioavailability is described herein as the portion of an administered dose of a nutraceutical, which reaches the systemic circulation.

An affected nutraceutical is defined herein as a nutraceutical that its bioavailability is affected by the presence of another nutraceutical.

An affecting nutraceutical is defined herein as a nutraceutical that has an effect on the bioavailability of another nutraceutical.

Each affected nutraceutical is assigned an interaction value corresponding to each one of the affecting nutraceuticals. The interaction value corresponds to the effect (increase or decrease) that the affecting nutraceutical has on the bioavailability of the affected nutraceutical.

In some embodiments, the information regarding the effect of affecting nutraceuticals on affected nutraceutical is retrieved by known methods, e.g. either by researching the literature or by conducting experiments, and is stored in the database described below. In some embodiments, the information is stored in databases outside the system of the present invention and is accessible by the system of the present invention.

In some embodiments, the information is preprocess by the system described below to yield interaction values corresponding to each pair of affected and affecting nutraceuticals and these interaction values are associated with the corresponding nutraceuticals in the database.

In some embodiments, the database is designed so that it can be scanned in order to retrieve interaction values for nutraceuticals as needed.

After at least one affected nutraceutical is identified in the list, the individualized daily dose associated with at least one of the identified affected nutraceuticals is adjusted according to the interaction value of the identified affected nutraceutical and at least one of the affecting nutraceuticals, using a bioavailability adjustment algorithm described below (400);

However, if an affecting nutraceutical completely abolishes the bioavailability of an affected nutraceutical, this interaction is associated with an interaction value of 0, and the individualized daily dose of the affected nutraceutical is not adjusted to compensate for this interaction.

According to certain embodiments, an individualized daily dose below a certain threshold (e.g., 10% of the recommended daily dose) is meaningless and does not require providing to the individual.

The list is outputted (500) by presenting it (e.g. by printing it or by presenting it on a screen), and/or by transmitting it to one or more external devices. Additionally or alternatively, the list is further processed by the same processor or by an external one.

According to some embodiments of the present invention, the output data is converted into machine readable data commands for allowing automatic preparation of dosage forms (550).

The list of nutraceuticals with their associated individualized daily dose, after adjusting according to the bioavailability adjustment algorithm, can then be used to generate dosage forms based on the individualized daily doses calculated for each nutraceutical.

In some embodiments, the amount of a certain nutraceutical may not be identical to the individualized daily dose calculated as described above, but an amount close to it. For example, pre-mixed preparations of several nutraceutical that are frequently needed together may be prepared in several amounts, and the preparation with amounts most similar to the individualized daily doses calculated according to the invention is selected.

According to certain embodiments, the nutraceuticals are designed to be taken on a daily basis. According to certain embodiments, the nutraceuticals according to the present invention can also be provided periodically at a different frequency such as once every two days or once weekly, etc. It is therefore appreciated that the use of the term “daily” in this application can be extended to include other frequencies as well, such as once every two days, weekly, etc.

Supplements can also be provided based on daily activity or per event, e.g., per single practice. The formulation provided in such cases is determined by the type, and the levels of intensity and endurance of the practice as described in more detail below.

According to certain embodiments, the personalized list of nutraceuticals with their associated individualized daily doses is provided for a certain period of treatment. According to certain embodiments, the treatment period is three months. According to certain embodiments, the treatment period is one month. According to certain embodiments, the treatment period is short, for example, one week, one day, several hours or just once.

According to certain embodiments, the personalized list of nutraceuticals with their associated individualized daily doses is reevaluated after each period with respect to parameters, e.g. changes in diet and medical conditions, and the list of nutraceuticals or their associated individualized daily doses may be changed as a result of reevaluation.

According to certain embodiments, the list of nutraceuticals of the invention can be supplemented by taking an additional combination of nutraceuticals on a “per event” basis, before or after the event. For example, before physical exercise, a specific formulation is taken, adapted to the type of exercise. In a specific example, for moderate endurance exercise the formulation is 300 mg of a lipoic acid, 600 mg of N-acetyl cysteine (Nac), 5 gr of glutamine, 6 gr of branched chain amino acid (BCAA) and 2 gr creatine; for extensive endurance exercise 600 mg of a lipoic acid, 1 gr of N-acetyl cysteine (Nac), 12 gr of glutamine, 12 gr of branched chain amino acid (BCAA) and 3 gr creatine; for moderate strength exercise 2 gr of hydroxyl methylbutyrate (HMB), 3 gr of b-alanine, and 2 gr of creatine; and for extensive strength exercise 4 gr of hydroxyl methylbutyrate (HMB), 4 gr of b-alanine, and 3 gr of creatine.

According to certain embodiments, the additional combination of nutraceuticals is defined by the type, and the levels of intensity and endurance of the physical activity performed by an individual.

According to certain embodiments, the additional combination of nutraceuticals is not provided continuously, but intermittently. For example, the nutraceuticals are provided for a limited period of time, e.g. a month, followed by a break of the same period. The cycle is then repeated.

According to certain embodiments, the additional nutraceuticals can be provided per event or per day and formulated according to the specific activity performed on that event or that day. For example, if an individual performs physical activity defined as “highly intense anaerobic” on a certain day, such as weight lifting, and “highly intense aerobic” activity on another day, such as dancing, the individual will receive several packages of different formulations of nutraceuticals, each prepared for a certain activity, for taking before or after performing that activity, or on the day of performing that activity.

Thus, the present invention provides a method for providing a personalized list of dietary nutraceuticals to an individual, wherein at least one of the nutraceuticals affects the bioavailability of at least one other of the nutraceuticals, the method comprising the steps of:

receiving parameters related to the individual (i);

generating a list of nutraceuticals to be taken by the individual comprising nutrients, the list being generated according to the parameters received, wherein each of the nutrients is associated with an individualized daily dose defined at least according to the parameters received (ii);

identifying in the list at least one affected nutraceutical, the bioavailability of which being influenced by at least one affecting nutraceutical comprised in the list, wherein the influence of each of the at least one affecting nutraceutical on the at least one affected nutraceutical is independently represented by a respective interaction value (iii);

adjusting the individualized daily dose associated with at least one of the affected nutraceutical identified in step (iii) according to at least one of said respective interaction values, using a bioavailability adjustment algorithm (iv); and

outputting the list of nutraceuticals with their associated individualized daily doses (v).

Minimal and Maximal Daily Values Associated with Medical Conditions

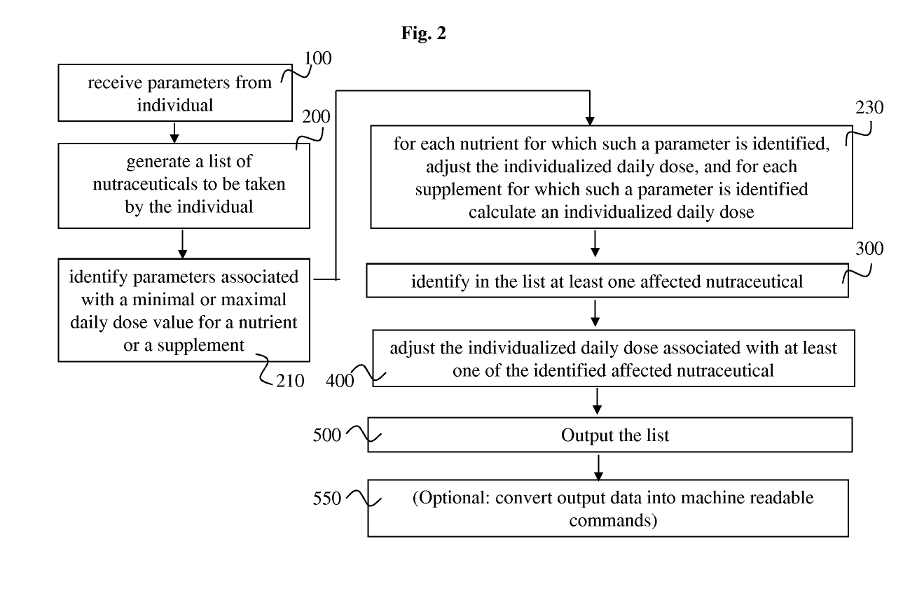

As shown in FIG. 2, after generating a list of nutraceuticals as shown in FIG. 1 (200) parameters are identified, which are associated with a minimal or maximal daily dose value for a nutrient or a supplement (210) and for each nutrient or supplement found, the individualized daily dose is adjusted according to a dose defining algorithm, and for each supplement found an individualized daily dose is calculated according to a daily dose defining algorithm (230).

The method then continues according to step (300) of FIG. 1, however the individualized daily dose is not further adjusted according to step (400) of FIG. 1 for affected nutrients, for which the individualized daily dose has been adjusted in step (230) because of a parameter associated with a minimal or maximal daily dose value.

Certain parameters are associated with a maximal value for certain nutraceuticals, which is herein defined as a daily value which must not be exceeded, and/or a minimal value for certain nutraceuticals, which is herein defined as a daily value which should be provided.

In some embodiments, maximal or minimal daily values of certain nutraceuticals which are associated with certain parameters are stored in the database and associated with the corresponding nutraceuticals such that these values can be retrieved as needed.

Certain medical conditions require providing an amount of a nutrient higher than defined according to DRI tables, e.g., a blood test result indicating a hemoglobin value lower than 13.5 g/dl in a 40 year-old man, requires providing 18 mg/day of iron instead of 8 mg/day according to DRI tables. Other conditions require that the level of certain nutraceuticals does not exceed a certain amount, for example, a blood test result with zinc level higher than 120 μg/dl, requires limiting the daily dose of zinc to zero, instead of any recommended daily dose according to DRI tables.

Such medical conditions are associated with minimal and/or maximal values for the relevant nutraceuticals. For example, for the medical condition “osteoporosis” minimal and maximal values are defined as follows: for the nutrient “calcium” the minimal value is 1000 mg/day; for the nutrient “magnesium” the minimal is 150 mg/day; for the nutrient “Vitamin D” the minimal value is 20 μg/day, and for the nutrient “Boron” the minimal value is 2 mg/day. According to a certain embodiment, each medical condition is associated with a value for each nutraceutical, wherein a certain value, e.g. a value of 1 means that the medical condition does not have a minimal or maximal value associated with that nutraceutical.

Additional parameters can also be associated with minimal and/or with maximal values. For example, if a subject is a vegetarian athlete engaged in extensive physical activity, certain nutraceuticals are provided, such as CoQ10, grape seed extract and CLA, and certain nutraceuticals should not be provided, for example, nutraceuticals derived from meat or fish products, such as omega-3 and fish oil, which are of fish origin. These products are included, for example, in two formulations—a formulation for dislipidemia and a formulation for individuals consuming less than two portions of fish per week (as indicated in Table 1). Therefore, a parameter indicating that the individual is a vegetarian or a vegan is associated with a maximum value of 0 for nutraceuticals which should not be provided to a vegetarian or a vegan, such as omega-3 or fish oil and formulations including them.

Additionally, allergies and sensitivities to food products may require that certain nutraceuticals be avoided in order to prevent an allergic reaction. Such allergies or sensitivities include, for example, soy allergy, gluten sensitivity, and fish sensitivity. Accordingly, a parameter indicating that an individual has certain allergies or sensitivities is associated with a maximum value of 0 for nutraceuticals for which the subject is allergic or sensitive. For example, a parameter indicating that the individual has fish sensitivity is associated with a maximum value of 0 for nutraceuticals derived from fish products, such as omega-3.

A maximum value of 0 means that the individual cannot take the nutraceutical at all. For example, a patient taking Coumadin for high blood pressure cannot take the supplement Q10 and therefore the maximum value associated with Coumadin and Q10 is 0.

According to certain embodiments, a minimal value for certain supplements is defined also in relation to physical activity level of the individual.

The activity level of an individual is calculated based on the total energy level used, which in turn is calculated based on physical exercise and work activities retrieved from the individual, according to the caloric values in Tables 2 and 3. The total energy spent in PAL (Physical Activity Level) is calculated for each activity according to the following formula: (E−SF)*H/7/17.5, wherein E is the caloric value for that activity in kilocalories; H are the weekly hours spent at that activity, SF represents a sleep factor which is determined by the system administrators; to get the daily average the result is divided by 7; the division by 17.5 is the result of conversion. The total energy spent is calculated by adding the results for each individual activity and then adding 1.1.

The resulting daily value of total energy spent is further categorized into four levels of activities: light (total between 1.1-1.4 PAL); medium (total between 1.4-1.6 PAL); heavy (total between 1.6-1.9 PAL); and professional (total above 1.9 PAL).

High energy level activities pose higher demands on the body and therefore require more resources. Accordingly, it is recommended that people engaged in intense physical activities are provided with certain supplements, such as CoQ10.

Therefore, according to certain embodiments, parameters related to physical activities with PAL above 1.6 are associated with minimal values for certain supplements or with a certain predefined formulation of supplements.

In certain embodiments, for individuals defined as “sport clients”, Resting Metabolic Rate (RMR) is used according to the following calculation, instead of the PAL calculation described above:

RMR (Male)=66+13.8*(Weight in kg)+5*(Height in cm)−6.8*(Age in years).

RMR (Female)=655+9.5*(Weight in kg)+1.9*(Height in cm)−4.7*(Age in years).

In some embodiments, the RIVIR value is further multiplied by a value reflecting the type of work, e.g. whether easy or hard.

Thus, according to certain embodiments, the method further comprises prior to step (iii) identifying at least one of the parameters received which is associated with a minimal or maximal daily dose value for at least one of the nutrients comprised in the list, and adjusting the individualized daily dose associated with the at least one nutrient according to a dose defining algorithm, wherein the individualized daily dose of the at least one nutrient is not further adjusted according to step (iv).

According to certain embodiments, the method further comprises identifying prior to step (iii) at least one of the parameters received which is associated with a minimal or maximal daily dose value for at least one dietary supplement, and adding each one of the at least one dietary supplement to the list of nutraceuticals, wherein for each one of the at least one dietary supplement, an individualized daily dose is calculated according to a dose defining algorithm.

In case that more than one parameter is associated with minimal and maximal values for the same nutraceutical, the lowest maximum value should not be exceeded. For example, the recommended minimal daily value for DHA (omega-3) may be set at 350 mg for a generally healthy individual. If the subject has the medical condition “heart disease”, associated with minimal DHA of 600 mg, then DHA must be replenished to a daily dose of 600 mg. However, if the patient additionally suffers from the condition “low blood clotting”, associated with a maximum DHA value of 100, then a daily value of 100 mg DHA must not be exceeded.

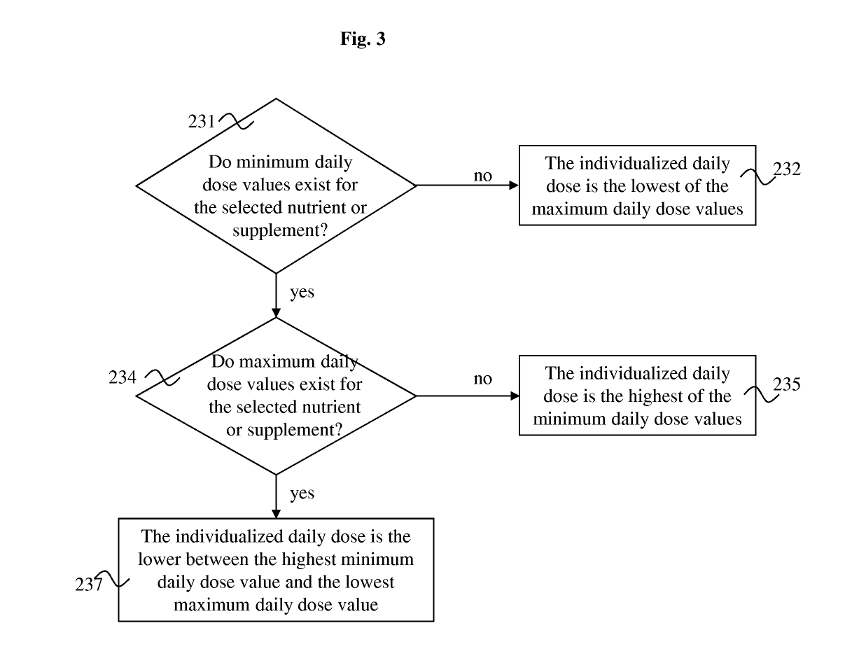

As shown in FIG. 3, according to some embodiments, the daily dose defining algorithm for cases where there is a parameter associated with minimal or maximal daily dose values for nutraceuticals includes the following steps: check whether minimal daily dose values exist for the selected nutrient or supplement (231). If no minimal daily dose values exist then the individualized daily dose is the lowest of the maximum daily dose values (232). If minimal daily dose values exist, checking whether maximal daily dose values exist for the selected nutrient or supplement (234). If no maximal daily dose values exist then the individualized daily dose is the highest of the minimal daily dose values (235). If both minimal and maximum daily values exist, then the individualized daily dose is the lower between the highest minimal daily dose value and the lowest maximum daily dose value (237).

According to certain embodiments, the dose defining algorithm for each one of the at least one nutrient or each one of the at least one dietary supplement comprises:

reviewing the minimal or maximal daily dose value associated with each of the at least one parameter identified and the nutrient or supplement (i); and

defining the individualized daily dose for the nutrient or the supplement (ii) as:

the highest of the minimal daily dose values when the minimal or maximal daily dose values comprise only minimal daily dose values (iia);

the lowest of the maximal daily dose values when the minimal or maximal daily dose values comprise only maximal daily dose values (iib); or

the lower between the highest minimal daily dose value and the lowest maximal daily dose value when the minimal or maximal daily dose values comprise at least one minimal daily dose value and at least one maximal daily dose value (iic).

According to certain embodiments, the daily dose calculated by the daily dose defining algorithm replaces the recommended daily dose based on DRI tables rather than replacing the individualized daily dose (which takes into account dietary intake). For example, if an individual needs, according to DRI tables, at least 8 mg of iron, and the individual has a low level of iron based on a blood test, a condition which requires 30 mg iron, then 30 mg will be used to calculate the amount of iron needed. Additionally, a maximum value overrides the DRI value or any minimal value. For example, if a woman needs a minimal daily value of 75 mg vitamin C according to DRI tables but her blood test shows that the level of Uric Acid is higher than 6.5 mg/dL, a condition assigned a maximal value of 0 mg daily for vitamin C, then she will not receive any Vitamin C.

According to certain embodiments, in the case of an overlap in certain nutraceuticals in different supplement formulations, which are both on the list, one of the formulations will override the other in order to prevent exceeding the recommended levels of the common nutraceutical. According to a further embodiment, one of the formulations will be associated with a maximum value of 0 for the other formulation. For example, if the individual is a woman suffering from digestive track problems, two supplement formulations including probiotics, e.g. Prana-Probiotics designed for subjects with digestive track problems, and Prana-Women, designed for women (see Table 1), are added to the list. However, the woman will only receive the Prana-Women formulation because it is associated with a maximum value of 0 for the Prana-Probiotics formulation, so that a woman receiving Prana-Women formulation will not also receive Prana-Probiotics formulation, even if having digestive track problems.

Time Limit for Taking Nutraceuticals

According to certain embodiments of the present invention, a time limit is defined for taking certain nutraceuticals. For example nutraceuticals taken for correcting a deficiency found in blood tests will only be taken for a limited time period, unless new blood tests are provided which show a continued requirement.

According to some embodiments, if an individual indicates taking a nutraceutical not according to a prescription by a physician, and blood work results indicate a need for that nutraceutical, this nutraceutical will be included in the list and the nutraceuticals provided by the present invention will replace the nutraceuticals taken by the individual. However, if the nutraceutical is also associated with a time limit for taking it, then the individualized daily dose is recalculated to account for the amount of nutraceutical already taken by the individual. However, if a subject indicates taking a nutraceutical not according to a prescription by a physician and either: no blood work results are provided, blood work results are provided but do not indicate a need for that nutraceutical, or the nutraceutical has been taken for longer than the time limit associated with that nutraceutical, then instructions will be provided, indicating to stop taking the nutraceutical.

Thus, according to certain embodiments, the individualized daily dose for the at least one nutraceutical is adjusted before step (iii) to accommodate for prior intake of the nutraceutical.

According to certain embodiments, in the case of a nutraceutical which can be taken at different doses either to replenish a gap between the daily diet and the recommended daily dose (first dose type) or because of a medical condition (second dose type), as described above, if there is a time limit associated with the second dose type for that nutraceutical, then after the time limit has expired and in the absence of additional blood work indicating a continuing need for the second dose type, the first dose type will be provided.

The Bioavailability Adjustment Algorithm

As described briefly above, some nutraceuticals have an effect on the bioavailability of other nutraceuticals, for example, by increasing or decreasing the absorption thereof, and interaction values corresponding to this effect are assigned to each pair of nutraceuticals, as explained above. For example, probiotic supplements can decrease the absorption of certain nutraceuticals. If the list of nutraceuticals includes pairs having interaction values that are different from a predefined neutral interaction value and also different from 0, then the individualized daily dose of affected nutraceuticals is corrected to compensate for the effect by the affecting nutraceuticals on the bioavailability thereof, according to a bioavailability adjustment algorithm.

The interaction value is composed of a fraction effect on bioavailability, which is added to (in the case of an increase in bioavailability) or subtracted from (in the case of a decrease in the bioavailability) a predefined neutral interaction value. The fraction effect represents the fraction reduction or increase in bioavailability of the affected nutraceutical as a result of the effect by the affecting nutraceutical.

According to certain embodiments described hereinbelow, the neutral interaction value is 1. However, a value other than 1 can be the neutral interaction value. An interaction between a nutraceutical which does not have an effect on the bioavailability of another nutraceutical is assigned the neutral interaction value.

Interaction values higher than the neutral interaction value are assigned to an interaction between affected nutraceuticals and affecting nutraceuticals having a positive effect on the bioavailability of an affected nutraceutical. For example, if the neutral interaction value is 1 and an affecting nutraceutical elevates the absorption of an affected nutraceutical by 5%, then the interaction value of the affecting nutraceutical and the affected nutraceutical is 1.05.

Interaction values lower than the neutral interaction value are assigned to an interaction between affected nutraceuticals and affecting nutraceuticals having a negative effect on the bioavailability of an affected nutraceutical. For example, if the neutral interaction value is 1 and an affecting nutraceutical decreases the bioavailability of an affected nutraceutical by 20%, the interaction value assigned to the interaction between the affecting nutraceutical and the affected nutraceutical 0.8.

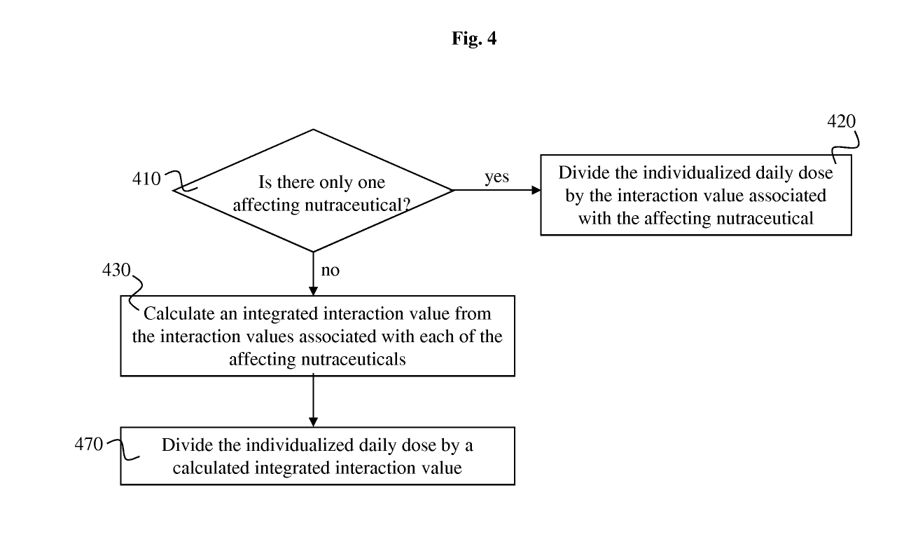

According to certain embodiments described in FIG. 4, the bioavailability determining algorithm is calculated as follows: check whether there is only one affecting nutraceutical (410). If there is only one-divide the individualized daily dose by the interaction value associated with the affecting nutraceutical (420). If there are more than one affecting nutraceuticals, then an integrated interaction value is calculated from the interaction values associated with each of the affecting nutraceuticals (430) and the individualized daily dose is divided by the calculated integrated interaction value (470).

Thus, according to certain embodiments, the adjusting the individualized daily dose associated with at least one of the affected nutraceutical in step (iv) comprises:

dividing the individualized daily dose by an interaction value associated with the at least one affecting nutraceutical and the affected nutraceutical when the at least one affecting nutraceutical is a sole affecting nutraceutical (i); or

dividing the individualized daily dose by an integrated interaction value calculated from the interaction values associated with each one of the affected nutraceutical and each of the at least one affecting nutraceutical when the at least one affecting nutraceutical comprises more than one affecting nutraceutical (ii).

Calculating the integrated interaction value can be done according to several different methods.

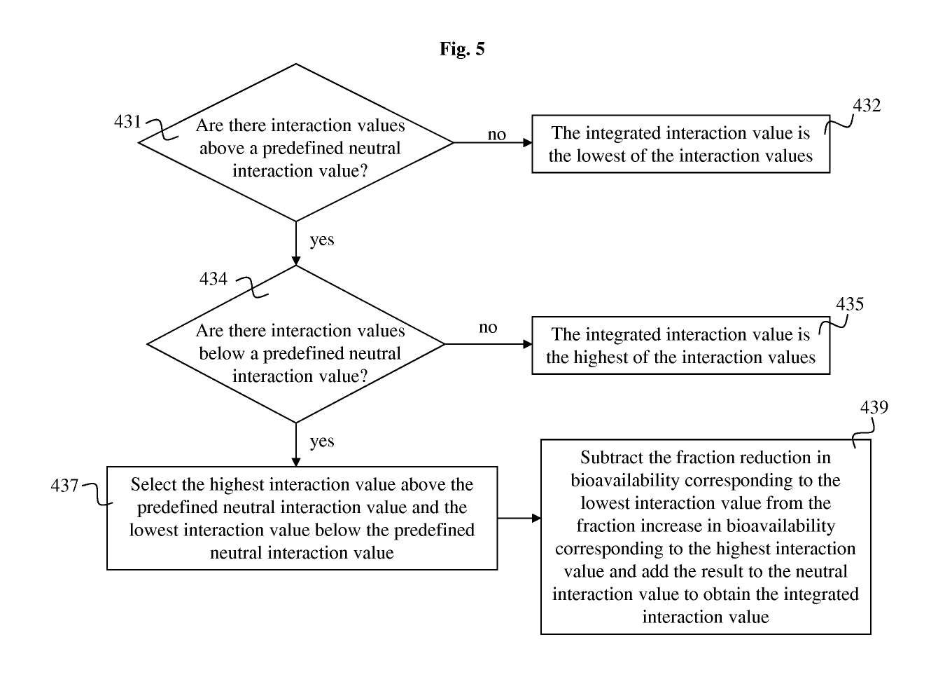

According to a certain embodiment described in FIG. 5, the integrated interaction value is calculated as follows: check whether there are interaction values above a predefined neutral interaction value (431); if there are none, then the integrated interaction value is the lowest of the interaction values (432); if there are, check whether there are interaction values below a predefined neutral interaction value (434); if there are none then the integrated interaction value is the highest of the interaction values (435); if there are both interaction values above and below the neutral interaction value, then the highest interaction value above the predefined neutral interaction value and the lowest interaction value below the predefined neutral interaction value are selected (437); and the fraction reduction in bioavailability corresponding to the lowest interaction value is subtracted from the fraction increase in bioavailability corresponding to the highest interaction value and the result is added to the neutral interaction value to obtain the integrated interaction value (439).

For example, if the neutral value is 1, the highest interaction value is 1.3, corresponding to an increase of 30% in bioavailability (fraction of 0.3) and the lowest interaction value is 0.8, corresponding to a decrease of 20% in bioavailability (fraction of 0.2), then the integrated interaction value is 0.3−0.2+1=1.1.

The terms “positive interaction value” and “negative interaction value” are used herein for simplicity and are relative to the neutral interaction value. Accordingly, a positive interaction value is an interaction value higher than the neutral interaction value, corresponding to a positive effect on bioavailability, and a negative interaction value is an interaction value lower than the neutral interaction value, corresponding to a negative effect on bioavailability.

Thus, according to certain embodiments, the at least one affecting nutraceutical comprises more than one affecting nutraceuticals, and:

all of the interaction values are above a predefined neutral interaction value, and the integrated interaction value is the highest of the interaction values (i);

all of the interaction values are below a predefined neutral interaction value, and the integrated interaction value is the lowest of the interaction values (ii); or

some of the interaction values are above and some of the interaction values are below a predefined neutral interaction value, and the integrated interaction value reflects the combination of the highest of the interaction values above the predefined neutral interaction value and the lowest of the interaction values below the predefined neutral interaction value (iii).

According to an alternative embodiment, the integrated interaction value is calculated by multiplying the interaction values of the various nutraceuticals affecting the same affected nutraceutical. For example, if the interaction values associated with a certain affected nutraceutical and several affecting nutraceuticals from the list are 0.2, 0.7 and 1.8, then the integrated interaction value according to this embodiment is 0.2*0.7*1.8=0.252.

Thus, according to certain embodiments, the at least one affecting nutraceutical comprises more than one affecting nutraceuticals, and the integrated interaction value is calculated by multiplying all of the interaction values associated with the affected nutraceutical and each of the at least one affecting nutraceutical.

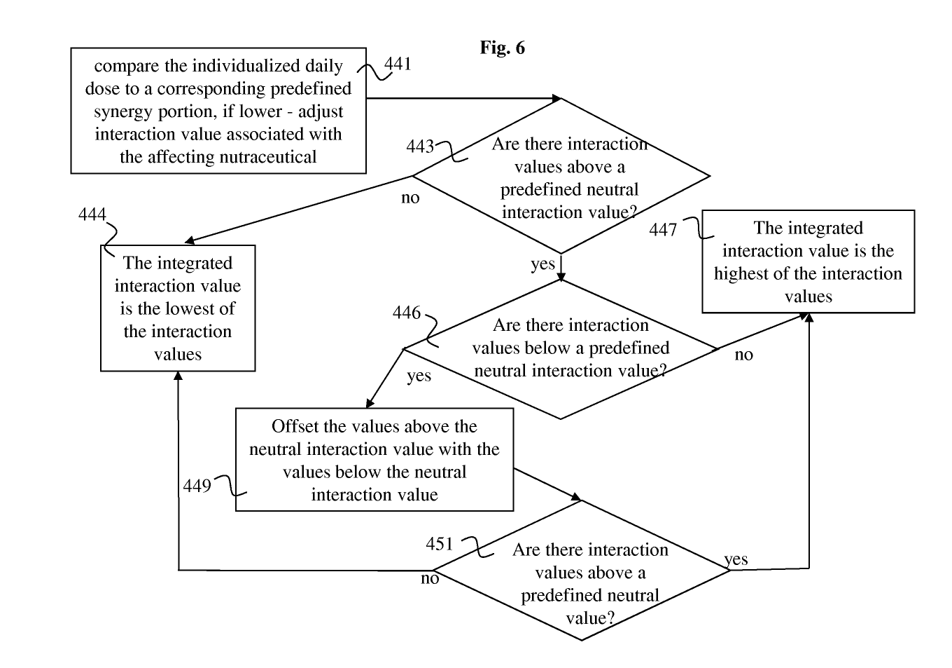

According to yet another alternative embodiment described in FIG. 6, the integrated interaction value is calculated as follows:

For each affecting nutraceutical define a value termed “synergy portion”, representing the amount of nutraceutical for which the interaction value is in effect. Compare the individualized daily dose for each affecting nutraceutical to the corresponding predefined synergy portion, and if lower—adjust the interaction value associated with the affecting nutraceutical to reflect the ratio between the individualized daily dose and the synergy portion (441).

It is appreciated that the synergy portion value can be defined for each affecting-affected nutrient pair. Alternatively, the synergy portion can be a feature of the affecting nutraceutical regardless of the affected nutraceutical.

Check whether there are interaction values above the predefined neutral interaction value (443), and if only nutraceuticals having a negative effect on the bioavailability of the affected nutraceutical (with interaction values below the neutral value) are present on the list, then the nutraceutical with the lowest interaction value, after adjustment based on the synergy portion as described above, is chosen as the integrated interaction value (444).

For example, iron, zinc and vitamin A are all included in the list of nutraceuticals. Zinc reduces by 10% the absorption of iron (corresponding to an interaction value of 0.9 and a fraction effect of 0.1), its defined synergy portion is 4 milligrams and the individualized daily dose is 9 milligrams (more than the synergy portion). Vitamin A reduces iron absorption by 12% (corresponding to an interaction value of 0.88, which is lower than that of zinc), its synergy portion is 600 micrograms and the individualized daily dose is 300 micrograms. The adjusted interaction value for vitamin A is 300/600*12%=6% (fraction effect of 0.06), corresponding to an interaction value of 0.94, which is higher than 0.9 of zinc. Therefore, the chosen lowest integrated interaction value is 0.9 of zinc.

If there are interaction values above a predefined neutral value, check whether there are interaction values below a predefined neutral interaction value (446), and if there are none, the integrated interaction value, after adjustment to account for the synergy portion, is the highest of the interaction values (447).

In the case that several affecting nutraceuticals have a positive effect on the bioavailability of an affected nutraceutical and several affecting nutraceuticals have a negative effect on the bioavailability of the same affected nutraceutical, after adjusting the interaction values to account for the synergy portion, offset the interaction values on either side of the neutral value against each other until only interaction values higher or only interaction values lower than the neutral value are left (449). Then check whether there are interaction values above the predefined neutral value (451), and if there are none, the integrated interaction value is the lowest of the interaction values (444), and if they are all above the neutral value, the integrated interaction value is the highest of the interaction values (447).

Thus, according to certain embodiments, the at least one affecting nutraceutical comprises more than one affecting nutraceuticals, and the integrated interaction value is calculated according to the following steps:

defining for each of the at least one affecting nutraceutical a synergy portion and adjusting the interaction value associated with the affecting nutraceutical and the affected nutraceutical if the individualized daily dose for the affecting nutraceutical is less than the synergy portion, to reflect the ratio between the individualized daily dose and the synergy portion (i);

defining the integrated interaction value as the highest of the interaction values, wherein the interaction values for each of the at least one affecting nutraceutical are above a predefined neutral interaction value (ii);

defining the integrated interaction value as the lowest of the interaction values wherein the interaction values for each of the at least one affecting nutraceutical are below a predefined neutral interaction value (iii); and

offsetting the values above the predefined neutral interaction value with the values below the predefined neutral interaction value to until only interaction values above or only interaction values below the predefined neutral interaction value are left, wherein some of the interaction values are above and some of the interaction values are below the predefined neutral interaction value, and defining the integrated interaction value is as in (ii) or (iii) (iv).

According to a certain embodiment described herein, if the individualized daily dose for an affecting nutraceutical is lower than the synergy portion defined for that nutraceutical, then the interaction value associated with that affecting nutraceutical and the affected nutraceutical is adjusted by multiplying the corresponding fraction effect on bioavailability by the ratio of the individualized daily dose out of the synergy portion and adding it to the neutral value. For example, for a neutral value=1, if the relevant interaction value is 1.4 (corresponding to a fraction effect of 0.4) and the individualized daily dose is half of the synergy portion defined for the same nutraceutical, then the adjusted interaction value is 0.4*0.5+1=1.2.

According to a certain embodiment, the offsetting is done according to the following method: the nutraceutical having the highest interaction value is selected first and if there are several nutraceuticals having the same interaction value, then the nutraceutical having the largest amount of portions (which is the individualized daily dose divided by the defined synergy portion) is selected. Then a nutraceutical with an interaction value lower than the neutral value is selected such that the fraction effect on bioavailability thereof is the same as the fraction effect of the first nutraceutical (e.g., if the first interaction value is 1.3 corresponding to a 30% increase in bioavailability, then the second is preferably 0.7, corresponding to a 30% decrease in bioavailability), or the closest to it. If both fractions are the same, they are cancelled against each other and the next couple is selected according to the same method. If the fractions are not the same, then the lower fraction is subtracted from the higher and the remainder is offset against another nutraceutical selected in the same way in order to cancel the remainder or be close to it. The process is repeated until only values higher or only values lower than the neutral value are left, and the integrated interaction value is then defined as described above for values only above or below the neutral interaction value.

According to certain embodiments, it is also possible to define interaction values for combinations of nutraceuticals, which are different than the integrated interaction values calculated based on the individual interaction values as described above. For example, zinc, which reduces iron absorption by 10%, and vitamin B12, which elevates iron absorption by 5%, can be assigned to the same dosage form together with iron. The interaction value defined for this combination of zinc and vitamin B12 is 0.85, corresponding to a reduction in absorption by 15%.

According to additional embodiments, a threshold minimum is defined for interaction values representing negative effects on bioavailability, such that above such value the interaction value is rounded to the neutral interaction value. For example, in the neutral interaction value is 1, and the threshold is 0.97, indicating that 97% of an affected nutraceutical is absorbed and 3% is lost due to the presence of an affecting nutraceutical, then an interaction value with a certain affecting nutraceutical of 0.98 will be rounded to 1, corresponding to no effect.

According to a certain embodiment, wherein the individualized daily dose of a nutrient is adjusted according to a bioavailability adjustment algorithm, the adjusted individualized daily dose must not exceed the maximum value corresponding to that nutraceutical retrieved from DRI tables.

According to additional embodiments, in the case of affected supplements, wherein the individualized daily dose is not based on DRI values but on minimal or maximum values associated with medical conditions, the individualized daily dose adjusted according to the bioavailability adjustment algorithm must not exceed any maximal values defined for the individual due to medical conditions.

According to further embodiments, a threshold amount is defined for the affecting nutraceutical and only if the individualized daily dose for that nutraceutical exceeds the threshold amount, then the effect on bioavailability is considered. For example, magnesium reduced the absorption of calcium by 60%, corresponding to an interaction value of 0.4, and the threshold amount for this effect is 150 milligrams of magnesium. If a dosage form contains both calcium and magnesium, the individualized daily dose for calcium is adjusted due to this interaction only if the individualized daily dose of magnesium is more than 150 milligrams.

According to certain embodiments, a minimum threshold is defined such that interaction values lower than the defined minimum threshold value are rounded to 0.

According to a certain embodiment, once an interaction value has been defined for an affecting nutraceutical with an affected nutraceutical, the reciprocal interaction value, with the affected nutraceutical as affecting and with the affecting nutraceutical as the affected, is not defined. According to a more specific embodiment, a descending order of nutraceuticals is defined such that each nutraceutical is assigned interaction values only with nutraceuticals lower on the list.

According to certain other embodiments, certain parameters, e.g., smoking, can also have an effect on the bioavailability of certain nutraceuticals. For such parameters, interaction values are defined for each nutraceutical for which the bioavailability is affected by them, and these interaction values are included in adjusting the individualized daily dose according to the bioavailability adjustment algorithm, as explained above for affecting nutraceuticals.

According to some embodiments, in the case where there are several options for a combination of nutraceuticals based on the individual's data, several possibilities exist in order to reach the optimal combination. For example, the individual is provided with several different combinations in an amount enough for a week or two, which can be tried before deciding on the best one. Another option may be to provide a formulation which is similar to a formulation by another manufacturer, which has been successfully taken previously.

As mentioned above, the output data may be converted into machine readable data commands for allowing automatic preparation of dosage forms. In some embodiments, the list is further analyzed to determine the manner in which the nutraceuticals in the list and combinations thereof are to be mixed and produced for consumption by the respective individual. In these embodiments, the output of the process also includes machine-readable instructions as to how to produce the dosage forms.

Thus, according to certain embodiments, the method further comprises preparing at least one dosage form including the nutraceuticals comprised in the list, each of the nutraceuticals being in an amount based on its associated individualized daily value.

Dosage Forms Preparation

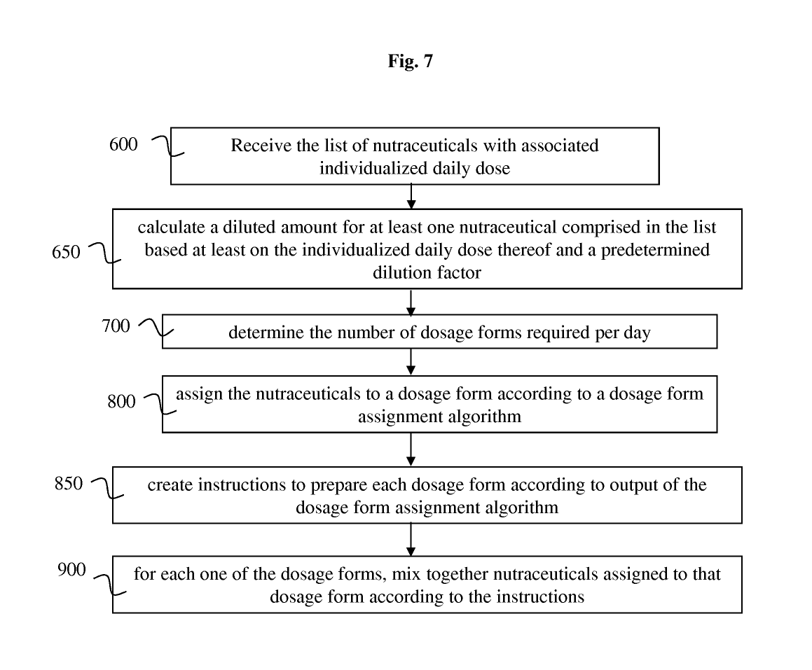

FIG. 7 is a flowchart showing a process for determining how the nutraceuticals in the list and combinations thereof are to be mixed and produced for consumption by the respective individual, according to some embodiments.

The process includes receiving the list of nutraceuticals with associated individualized daily dose (600); calculating a diluted amount for at least one nutraceutical comprised in the list based at least on the individualized daily dose thereof and a predetermined dilution factor (650).

Nutraceuticals are generally supplied as a mixture including the nutraceutical together with another inert substance. In order to calculate the diluted amount of the mixture, e.g., powder, that should be used for preparing the dosage forms, each nutraceutical is associated with a predetermined dilution factor indicating the fraction of the mixture constituting the nutraceutical itself out of the supplied mixture. The diluted amount is calculated by dividing the individualized daily dose by the corresponding dilution factor. For example, if calcium is provided as a mix with another substance such that each 100 grams of the mixture contain 80 grams of calcium, then the dilution factor is 0.8. If 300 mg of calcium are the individualized daily dose, then the amount of calcium mixture for adding is in fact 300/0.8=375 mg. In cases wherein the nutraceutical is a pure mixture without dilution, the dilution factor is 1.

Determining the Number of Dosage Forms Per Day

The number of dosage forms required per day is then determined according to dosage form number determining factors (700);

Certain situations require that the daily nutraceuticals be provided to the individual in more than one dosage form.

Such situations include, for example, the presence of nutraceuticals that cannot be mixed together due to technical reasons, for example, requiring different conditions, such as one nutraceutical being water-soluble and another being fat-soluble.

Additionally, the presence on the list of a nutraceutical that abolishes the bioavailability of another nutraceutical (interaction value of 0) also requires that the two nutraceuticals be provided in separate dosage forms. In this case, instructions will be provided indicating that the separate dosage forms should be taken at separate times.

Additional situations include the presence of a nutraceutical in an increased or a double dose due to a medical condition, as explained above, such as an elevated blood LDL level which is above the second maximal value and requires provided two tablets of phytosterols instead of one which is provided for a less elevated LDL level. The double dose is divided into separate dosage forms.

Nutraceuticals are assigned to a dosage form according to a dosage form assignment algorithm (800). Instructions are then created for preparing each dosage form according to output of the dosage form assignment algorithm (850). For each one of the dosage forms, nutraceuticals assigned to that dosage form are mixed together according to the instructions (900).

As described above, the diluted amount of all nutraceuticals on the list are added up to obtain the total amount of nutraceuticals to be provided daily. If the total amount of all nutraceuticals on the list exceeds the capacity of the largest dosage form available, then they must be split into more than one dosage form.

The number of dosage forms to be taken daily by the individual is determined based on dosage form number determining factors, such as for example, the total amount and/or the presence on the list of a nutraceutical that abolishes the bioavailability of another nutraceutical on the list.

The nutraceuticals on the list are divided between dosage forms according to a dosage form assignment algorithm and nutraceuticals assigned to each dosage form are mixed together.

According to certain embodiments, preparing the at least one dosage form comprises the steps of:

calculating a diluted amount for at least one nutraceutical comprised in the list based at least on the individualized daily dose thereof and a predetermined dilution factor (i);

determining the number of the at least one dosage form needed for packaging all nutraceuticals on the list according to dosage form number determining factors (ii);

assigning the nutraceuticals to the at least one dosage form, the number of which determined in step (ii), according to a dosage form assignment algorithm (iii); and

for each dosage form of the at least one dosage form, mixing together nutraceuticals assigned to the dosage form according to their respective diluted amount to thereby prepare the individual dietary nutraceuticals (iv).

According to certain embodiments, calculating a diluted amount for at least one nutraceutical comprised in the list is done by dividing the individualized daily dose of the nutraceutical by a predetermined dilution factor assigned to the nutraceutical.

According to certain embodiments, the dosage form number determining factors are selected from:

the presence of at least one nutraceutical of the list that abolishes the bioavailability of at least one other nutraceutical of the list (a);

the presence of at least one nutraceutical of the list, the individualized daily dose of which is divided into more than one daily intake (b);

the total amount of all nutraceuticals comprised in the list exceeds the capacity of the largest dosage form available (c); and

the presence of nutraceuticals comprised in the list which cannot be mixed together because of technical considerations (d).

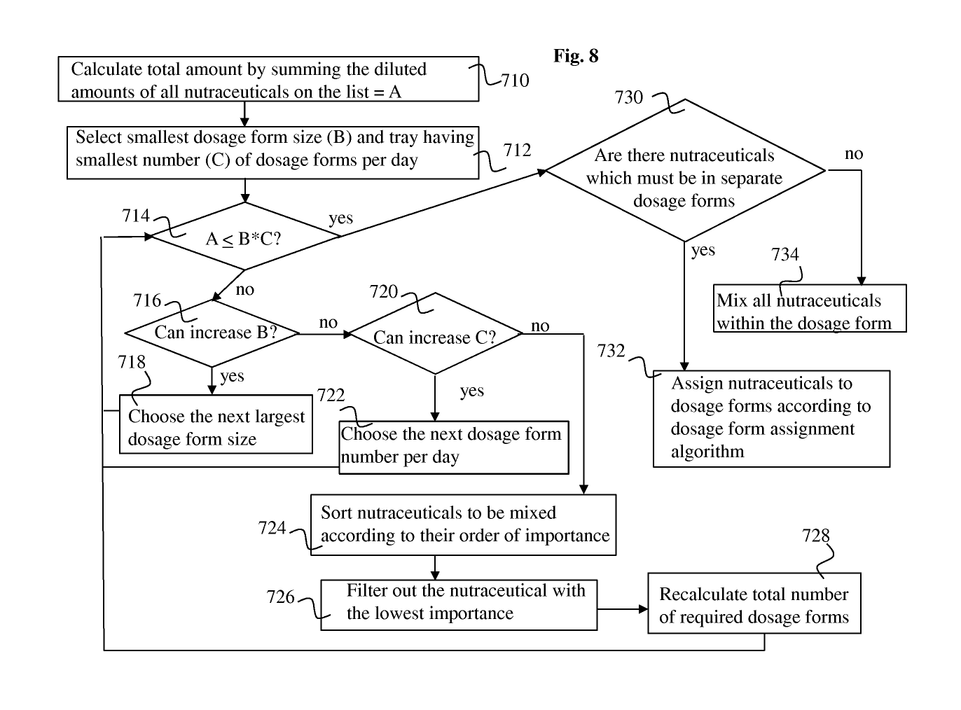

According to a specific embodiment, described in FIG. 8, the number of dosage forms per day is determined based on the calculated total amount, according to the following steps:

Calculate the total amount by summing up the diluted amounts of all nutraceuticals on the list (710); select the smallest dosage form size and the tray having the minimum number of dosage forms per day (712); check whether the diluted amount of all nutraceuticals is less than or equal to the maximum allowed weight of the selected dosage form size multiplied by the selected number of daily dosage forms in the tray (714); if not, check if the dosage form size can be increased (716); if yes—increase the dosage form size (718), and go back to (714); and if not possible to increase the dosage form size, check if possible to increase the tray having number of dosage forms per day (720); if yes, increase the number of dosage forms per day (722), and go back to (714); if not possible to increase the number of dosage forms per day either, sort nutraceuticals to be mixed according to their order of importance as defined below (724); filter out the nutraceutical lowest on the order of importance (726); recalculate total number of required dosage forms according to nutraceuticals left (728); and go back to (714).

If at (714) the diluted amount of nutraceuticals is less than or equal to the maximum allowed weight of the selected dosage form size multiplied by the selected number of daily dosage forms, then check whether there are nutraceuticals which must be in separate dosage forms (730); if there are, then assign nutraceuticals to dosage forms according to a dosage form assignment algorithm (732); if not then mix all nutraceuticals within the dosage form (734).

According to a certain embodiment described herein, several types of dosage forms exist. Each type of dosage form available is assigned a maximum allowed weight, calculated based on the volume of the dosage form and the volume to weight conversion factor. For example, if the volume of a dosage form is 0.95 ml and the volume to weight conversion factor is 700 mg/ml, then the amount of powder which can be packed in the dosage form is: Volume*conversion factor=0.95 ml*700 mg/ml=665 mg.

Additionally, each dosage form type is further associated with a flag indicating whether it is currently being manufactured.

According to a certain embodiment, selecting a dosage form is done by first selecting the smallest dosage form available and comparing its maximum allowed weight to the total diluted amount calculated as explained above. If the total amount exceeds the maximum allowed weight then a larger dosage form is selected, until a dosage form is found for which the maximum allowed weight is more than the total amount. If the total amount exceeds the largest dosage form then it is divided between more than one dosage forms.

Dosage forms are manufactured in trays of various sizes, each tray size including a different number of dosage forms. For each tray size, the number of dosage forms to be taken daily is calculated by dividing the total number of dosage forms in the tray by a value representing the number of days for which dosage forms are manufactured for an individual, referred to herein as batch, and taking the integer quotient of the division outcome.

The minimum number of dosage forms that an individual can take per day is calculated by dividing the total number of dosage forms in the smallest tray by the batch value and taking the integer quotient of the division outcome. The maximum number of dosage forms that an individual can take per day is also defined.

For example, if an individual receives a supply of dosage forms for three months (batch is 90 days) and the smallest tray holds 200 dosage forms, the minimum number if dosage forms to be taken daily is INT(200/90)=2.

According to a more specific embodiment, the number of dosage forms to be taken daily based on the total amount of nutraceuticals is defined according to the following process:

select the smallest dosage form size and the tray having the smallest number of dosage forms per day;

compare the total amount to the product of the maximum allowed weight of the selected dosage form times the selected number of dosage forms per day (i);

as long as the total amount is larger than the product, repeat step ii with a larger size dosage form until the largest size dosage form is reached (ii);

as long as the total amount is larger than the product, repeat steps ii and iii with a tray having a larger number of dosage forms per day (iii).

For example, if the total amount of nutraceuticals is 1500 mg, the minimum number of dosage forms per day is 2 and two size dosage forms exist, with maximum allowed weights of 660 mg and 900 mg, the smaller 660 mg dosage form multiplied by 2 dosage forms per day contains up to 1320 mg, which is still lower than 1500 mg. However, the 900 mg dosage form multiplied by two dosage forms per day contains up to 1800 mg, which is higher than 1500 and therefore this dosage form is selected.

According to a certain embodiment, if the maximum allowed weight of the largest dosage form multiplied by the largest number of dosage forms per day is still lower than the total amount of nutraceuticals, then some of the nutraceuticals are removed and not provided to the individual.

According to additional embodiments, combinations of different size trays can also be used if the number of daily dosage forms for the largest tray alone times the maximum allowed weight of the largest dosage form is less than the total amount. According to a more specific embodiment, the combination having the lowest number of trays is selected.

According to a specific embodiment, the least important supplement, as explained below, is removed first, and if needed, the next least important supplements are removed, until the amount is sufficiently small to fit in the dosage forms.

According to certain embodiments, nutraceuticals are graded in ascending or descending order of importance. The order of importance is determined by multiplying a value X representing a predefined importance level for each nutraceutical by a value Y corresponding to individualized daily dose for that nutraceutical. It is also possible to define a minimum threshold such that any X*Y lower than this value does not require providing the nutrient.

According to more specific embodiments, the value Y for nutrients is normalized by dividing by the recommended daily dose. For example, if the recommended daily dose is 800 and the daily intake is 600, then Y is calculated as: Yₙₒᵣₘ=(800−600)/800=0.25. According to a specific embodiment, Yₙₒᵣₘ for supplements is always 1.

According to additional embodiments, a certain number of dosage forms is destined for quality control and will not be sent to the individual. More specifically, the number of dosage forms for quality control is the reminder from dividing the number of dosage forms per tray by the batch.

According to a specific embodiment, if the remainder is less than the defined number of dosage forms destined for quality control, the batch number can be lowered, resulting in the tray designed for fewer days. Alternatively, the next size tray can be used, which may leave a larger remainder.

Specifically, the system first calculates these parameters for the largest tray and checks whether the resulting number of dosage forms per day is higher than the maximum number of dosage forms per day. If it is not, then the calculation is repeated where the number of dosage forms per day for the smallest tray is multiplied by 2. If the new value is still less than the maximal number per day, then this process continues. Once the new value is the same as the maximal number, then this process is stopped and this value is defined as the highest possible value from a manufacturing standpoint. Alternatively, if the value is higher than the maximal number, then the preceding value achieved form the previous iteration is defined as the highest possible value from a manufacturing standpoint.

If the number of dosage forms to be given daily to an individual is more than one, then after the number of dosage forms per day has been determined, the nutraceuticals must be distributed into the separate dosage forms according to a dosage form assignment algorithm.

Off-the-Shelf Items

Nutraceuticals are usually obtained in a powder form and are mixed together with other nutraceuticals for packing in a dosage form and providing to an individual. However, some nutraceuticals are also available as off-the-shelf items, i.e., are packaged and provided separately, and not mixed in a dosage form with other nutraceuticals.

Accordingly, each nutraceutical is associated with a value, herein termed “OEM” (Original Equipment Manufacturer), indicating whether the respective nutraceutical is available only as an off-the-shelf item (indicated by OEM=1), not available as an off-the-shelf item but only for mixing with other nutraceuticals (indicated by OEM=0) or available both as an off-the-shelf item and for mixing with other nutraceuticals (indicated by OEM=2). For example, phytosterols, probiotics or capsules of supplements for certain medical conditions are assigned OEM=1, meaning that these supplements are available only as off-the-shelf items and are not provided as powder for mixing with other nutraceuticals.

Thus, according to certain embodiments, at least one of the nutraceuticals comprised in the list is not mixed with other nutraceuticals comprised in the list and is provided as an off-the-shelf item.

Certain nutraceuticals can be given both as separate off-the-shelf items or mixed as powder into dosage forms with other nutraceuticals. According to some embodiments, these nutraceuticals can be either given separately as off-the-shelf items or mixed in as powder. In case the nutraceuticals are mixed in as powder, the nutraceutical is added in an amount which corresponds to the weight of one tablet of the off-the-shelf item multiplied by the recommended number of tablets.

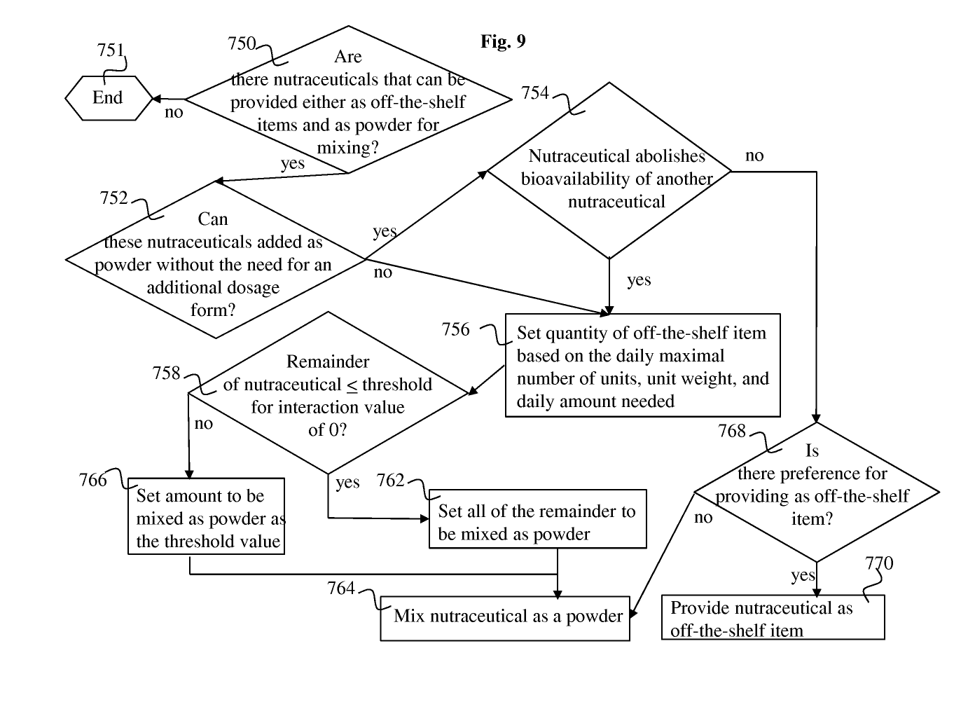

According to a specific embodiment illustrated in FIG. 9, the decision of whether to add a nutraceutical having OEM=2 as an off-the-shelf item or mix as powder is carried out as follows:

Check whether there are nutraceuticals that can be provided both as off-the-shelf items and as powder (750) and if not, terminate the process (751); if yes, check whether these nutraceuticals can be added as powder without exceeding the current dosage form maximum allowed weight and hence the need for an additional dosage form (752); is yes, check whether the nutraceutical abolishes bioavailability of another nutraceutical already assigned to that dosage form (754); if yes, set quantity of off-the-shelf item based on the daily maximal number of units, unit weight, and diluted amount needed of the nutraceutical (756); and check whether the remainder of nutraceutical is less than or equal to the threshold for interaction value of 0, i.e. for abolishing the activity of the other nutraceutical (758); if yes, then set all of the remainder to be mixed as powder (762), and mix nutraceutical as a powder (764).

If the answer at (758) is negative, then set the amount to be mixed as powder to be the threshold value (766) and mix nutraceutical as a powder (764).

If the answer at (754) is negative meaning that the nutraceutical does not abolish the bioavailability of another nutraceutical assigned to the dosage form, then check whether there is preference for providing as off-the-shelf item rather than mixing as powder (768); if not then mix nutraceutical as a powder (764).

If the answer at (752) is negative meaning that the dosage form maximum allowed amount will be exceeded, then set quantity of off-the-shelf item based on the daily maximal number of units, unit weight, and diluted amount needed of the nutraceutical (756), continue as above.

If the answer to (768) is positive then add the nutraceutical as a separate off-the-shelf item (770).

According to this embodiment, if at least one of the nutraceuticals, which must be separated because either they require different conditions or because one abolishes the bioavailability of the other, is available as an off-the-shelf item, then it can be provided separately as an off-the-shelf item instead of being provided in a separate dosage form. The instructions in this case will include a notice to take the dosage form and the off-the-shelf item at different times.

According to some embodiments, if adding the nutraceutical to the mixture will necessitate an additional dosage form, then preference can be defined as to whether it will be added as an off-the-shelf item or directly to the mixture. However, addition of the nutraceutical to the mixture in this case is only provided that this addition does not cause the total amount to exceed the largest dosage form weight limit multiplied by the maximal daily number of dosage forms.

According to some embodiments, if several nutraceuticals with OEM=2 can be added to the mixture but their addition will cause the total amount to exceed the largest dosage form weight limit multiplied by the maximal daily number of dosage forms, the system will calculate the amount of nutraceuticals which can be added, according to the difference between the maximum possible amount and the amount of nutraceuticals added with OEM=1. A combination of nutraceuticals with OEM=2 will be selected with the closest weight still not exceeding the calculated amount and the rest will be added as off-the-shelf items according to the method described above with reference to nutraceuticals with OEM=1.

In case the mixture was already divided into two dosage forms due to interaction values=0 between nutraceuticals with OEM=0, then addition of nutraceuticals with OEM=2 will be examined separately against each of the two mixtures as explained above. Any addition of dosage forms will be considered only after the possibility for adding nutraceuticals without adding dosage forms has been exhausted.

According to an additional embodiment, interaction values are calculated for nutraceuticals which are mixed together with other nutraceuticals in a dosage form but not for nutraceuticals given as off-the-shelf items.

According to certain additional embodiments, each nutraceutical provided as an off-the-shelf item is assigned additional values, indicating for each available product for the respective nutraceutical, the weight of a single unit. For example, if calcium is provided as an off-the-shelf item and there are two types of calcium pills, of 600 micrograms and of 300 micrograms, the additional variables assigned to the calcium off-the-shelf item include both 600 micrograms and 300 micrograms. Additionally, each of the variables is associated with a flag indicating whether this specific product is currently available in stock.

Dosage Form Assignment

According to certain embodiments, when assigning nutraceuticals to dosage forms, if no pair of nutraceuticals included in the list has an interaction value of 0, and no nutraceuticals require a different solvent or treatment during packaging, then the nutraceuticals are mixed homogeneously, an excipient or carrier is added as necessary, and the mixture is evenly distributed between the dosage forms.

In case nutraceuticals requiring different solvents or special treatment during packaging are included in the list, the nutraceuticals are first separated according to solvent requirements and other treatment requirements and each of the resulting lists is then examined further for assignment to a dosage form.

If at least one pair of nutraceuticals has an interaction value of 0, meaning that one nutraceutical abolishes the bioavailability of the other, then the two nutraceuticals are assigned to separate dosage forms.

The remaining nutraceuticals are then assigned to dosage forms based on a dosage form assignment algorithm.

According to certain embodiments described herein, the dosage form assignment algorithm takes into consideration interaction values between nutraceuticals such that nutraceutical having an interaction value above the neutral value are preferably assigned to the same dosage form, and nutraceuticals having an interaction value below the neutral value are preferably assigned to separate dosage forms.

Thus, according to certain embodiments, the dosage form assignment algorithm comprises assigning nutraceuticals to different dosage forms when one nutraceutical has a negative effect on the bioavailability of a second nutraceutical; and assigning nutraceuticals to the same dosage form when one nutraceutical has a positive effect on the bioavailability of a second nutraceutical.

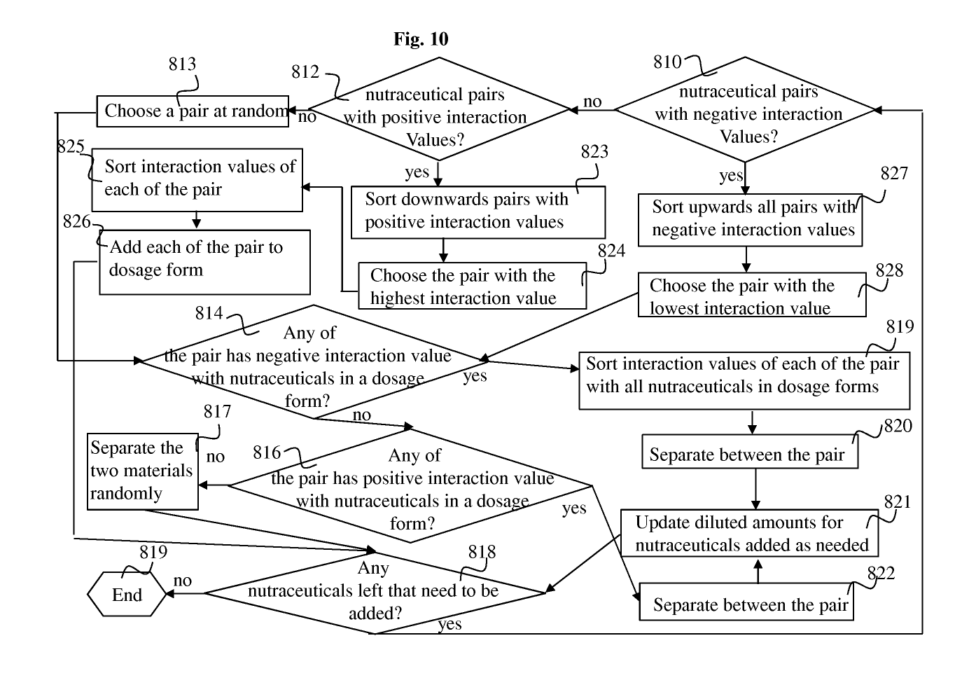

According to a specific embodiment, illustrated in FIG. 10, the dosage form assignment algorithm is carried out as follows:

Review the nutraceuticals to be added and check whether there are nutraceutical pairs with negative interaction values (lower than the neutral interaction value) (810); if not, check whether there are nutraceutical pairs with positive interaction values (higher than the neutral interaction value) (812), and if not, choose a pair at random to be the current pair for assigning to a dosage form (813). Check whether any of the nutraceuticals of the pair has negative interaction value with nutraceuticals already assigned to a dosage form (814). If not, then check whether any of the nutraceuticals of the pair has positive interaction value with nutraceuticals in a dosage form (816); if not then separate the two nutraceuticals randomly (817); Check whether any nutraceuticals are left that need to be assigned to a dosage form (818). If yes, then go back to (810) and if not, terminate the process (819).

If at (814) at least one of the nutraceuticals of the pair has negative interaction value with nutraceuticals already assigned to a dosage form, then sort interaction values of each nutraceutical of the current pair with all nutraceuticals already assigned to a dosage form (819), separate between the nutraceuticals of the current pair such that the nutraceutical of the current pair with the lowest interaction value with a nutraceutical already assigned to a first dosage form is added to a second dosage form and the other nutraceutical of the pair is assigned to the first dosage form (820); update the diluted amounts of assigned nutraceuticals based on interaction values between them according to a bioavailability adjustment algorithm, as needed (821); and go to (818).

If at (816) at least one of the nutraceuticals of the pair has positive interaction value with nutraceuticals already assigned to a dosage form, then separate between the current pair such that the nutraceutical of the pair with the highest interaction value with a nutraceutical already assigned to a first dosage form is added to the same dosage form and the other nutraceutical of the pair is added to a second dosage form (822), update the diluted amounts of assigned nutraceuticals based on interaction values between them according to a bioavailability adjustment algorithm, as needed (821); and go to (818).

If there are pairs to be assigned with positive interaction values at (812), then sort downwards all pairs with positive interaction values (823); choose the pair with the highest interaction value (824); sort interaction values of each of the pair with all nutraceuticals in dosage forms (825); add each of the pair to the dosage form not having the nutraceutical with the lowest interaction value (826); and go to (818).

If there are pairs to be assigned with negative interaction values at (810) then sort upwards all pairs with negative interaction values (827); choose the pair with the lowest interaction value (828); and go to (814).

According to some embodiments, if none of the nutraceuticals about to be added to a dosage form have an interaction value different from the neutral value with any of the nutraceuticals already assigned to any of the dosage forms, then they are added to the dosage form with the lowest total amount of nutraceuticals.

According to some embodiments, if nutraceuticals remain having an interaction value equal to the neutral value with all other nutraceuticals, then they are added in descending order of weight, each time to the dosage form currently having the lowest total amount of nutraceuticals.

Thus, according to certain embodiments, the diluted amount for each one of the nutraceuticals assigned to each one of the dosage forms is revised based on positive or negative effects on the bioavailability of the nutraceutical by other nutraceuticals assigned to the dosage form.

According to certain embodiments, in case the weight limit was exceeded for at least one of the dosage forms, resulting in removal of certain nutraceuticals, and if revision of amounts of nutraceuticals due to separation of nutraceuticals having interaction resulted in free space in the dosage form, then returning the removed nutraceuticals is considered. First the most important nutraceutical, having the highest X*Y value, is considered and added, if possible. If there is not enough space or space still left after its return, the next highest nutraceutical is checked, and so on. For each nutraceutical added, interaction values will be checked and corrections of amounts made, if necessary.

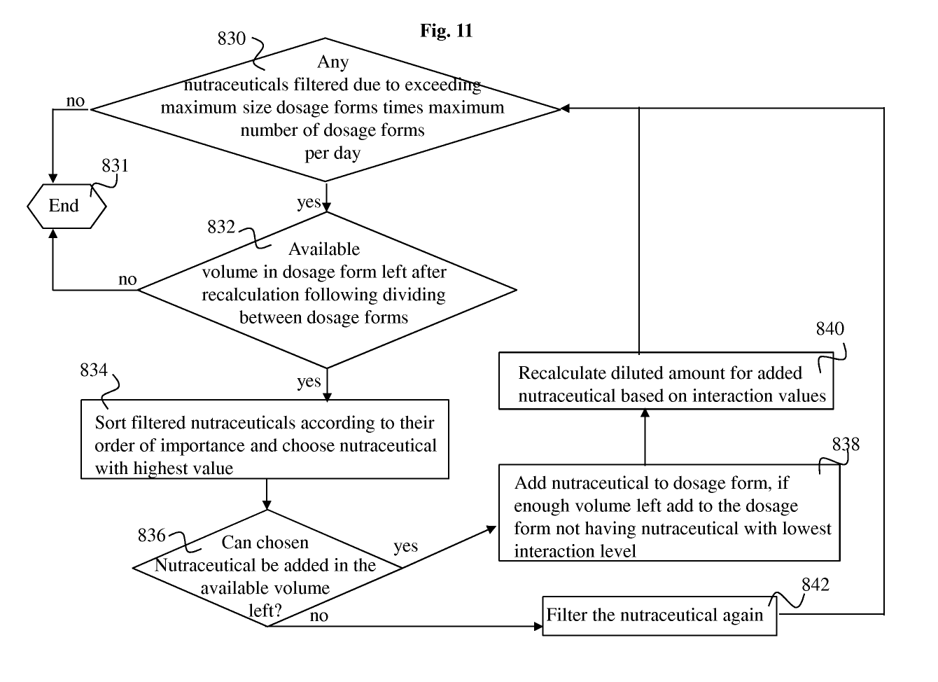

According to a specific embodiment described in FIG. 11, nutraceuticals are added back to the dosage form mixture according to the following steps:

Check whether nutraceuticals were filtered due to exceeding maximum allowed weight of the largest dosage form multiplied by the maximum number of dosage forms per day (830); if not, terminate the process (831), and if yes, check whether there is available volume in dosage form created due to diluted amount recalculation based on interaction values following dividing between dosage forms (832); if yes, then sort filtered nutraceuticals according to their order of importance and choose nutraceutical with highest value (834) and if not, terminate the process (831).

Check whether the chosen nutraceutical can be added according to the available weight left after conversion of volume to weight (836); if yes then add nutraceutical to dosage form, and if there is more than one dosage form with available volume, add the nutraceutical to the dosage form not having nutraceutical with lowest interaction value with the added nutraceutical, provided that there is enough volume left in that dosage form for adding the nutraceutical (838), recalculate diluted amount for added nutraceutical based on interaction values and bioavailability adjustment algorithm (840), and go to (830).

If the answer in (836) is negative, then filter the nutraceutical again (842); and go to (830).

According to some embodiments, for nutraceuticals for which OEM=1 (only off-the-shelf items), the combinations of product (referred to hereinbelow as “pills”) weights is checked to find the combination closest to the individualized daily dose value, but which does not exceed it. Preferably only the available unit sizes will be considered. This can be done by checking multiplicities or combinations of the different units. If more than one combination is found then the combination with the least amount of dosage forms is chosen.

Additionally, a daily maximal number of off-the-shelf item units can be defined, and any combination exceeding this maximum will not be used.

For example, a subject needs 820 mg of calcium daily. If OEM=1 and three types of pills are available: 100 mg, 300 mg and 600 mg, there are several possible combinations for reaching 820 mg (all below 820 mg):

1. one 600 mg pill (=600 mg)
2. two 300 mg pills (=600 mg)
3. eight 100 mg pills (=800 mg)
4. one 600 mg pill and two 100 mg pill (=800 mg)
5. two 300 mg pills and two 100 pills (=800 mg)

Options 3-5 all contain 800 mg, but option 4 has the least amount of pills and will therefore be chosen.

If in this case a daily maximum number of two calcium pills is assigned, then options 3-5 could not be used and option 1, with the least amount of pills (same mg amount as option 2) would be selected.

After the nutraceutical have all been assigned to dosage forms, they are mixed together for packaging. If additional material is needed to fill up a dosage form then carrier is mixed together with the nutraceuticals.

Thus, according to certain embodiments, step (iv) of preparing the at least one dosage form further comprises mixing a pharmaceutically acceptable carrier together with nutraceuticals assigned to at least one of the dosage forms.

A pharmaceutically acceptable carrier may be any acceptable carrier, including, for example, Microcrystalline Cellulose, Silicon Dioxide, Magnesium or Stearate.

According to certain embodiments, the dosage form is selected from a tablet, capsule, pill, softgel, gelcap, sachet, chewing gum, food snack, health bar, or beverage.

Time of Update

According to certain embodiments, each of the medical conditions is associated with two flags—one indicating whether an update is required after a certain period of time in order to continue providing nutraceuticals for this condition, and the second indicating the period of time for update, for example, three months.

For example, blood work results reveal vitamin B12 deficiency, for which the tested individual has already received B12. The nutrient vitamin B12 and the medical condition of vitamin B12 deficiency are associated with a value of 1 for update required, and a time for update of 6 months, meaning that an updated blood work is required after six months in order to continue treatment with vitamin B12. If the individual presents updated blood work at the required time and the vitamin B12 deficiency condition still exists, treatment with the B12 nutraceutical will continue, unless other medical conditions conflict with administration of vitamin B12.

If no updated results are provided at the required time, the medical condition is considered no longer to be present.

Any nutraceuticals taken for medical conditions for which an update is not required are unchanged.

According to a certain embodiment, if the amount of the nutrient needs to be changed, for example, as a result of an expired medical condition, e.g., since an update was required and not provided, the amount of the nutrient is recalculated based on the gap between dietary intake and minimal DRI value.

As a result, a subject who receives nutraceuticals which require an update after 6 months, nutraceuticals which require an update after 3 months, and nutraceuticals which do not require an update, will receive for the first three months a certain mixture of dietary nutraceuticals; then, unless updated results are presented the subject receives for the next three months a different mixture of nutraceuticals, not including the certain mixture which expired after three months; and if no updated results are presented again, a third mixture, also not including also the certain mixture which expired after six months.

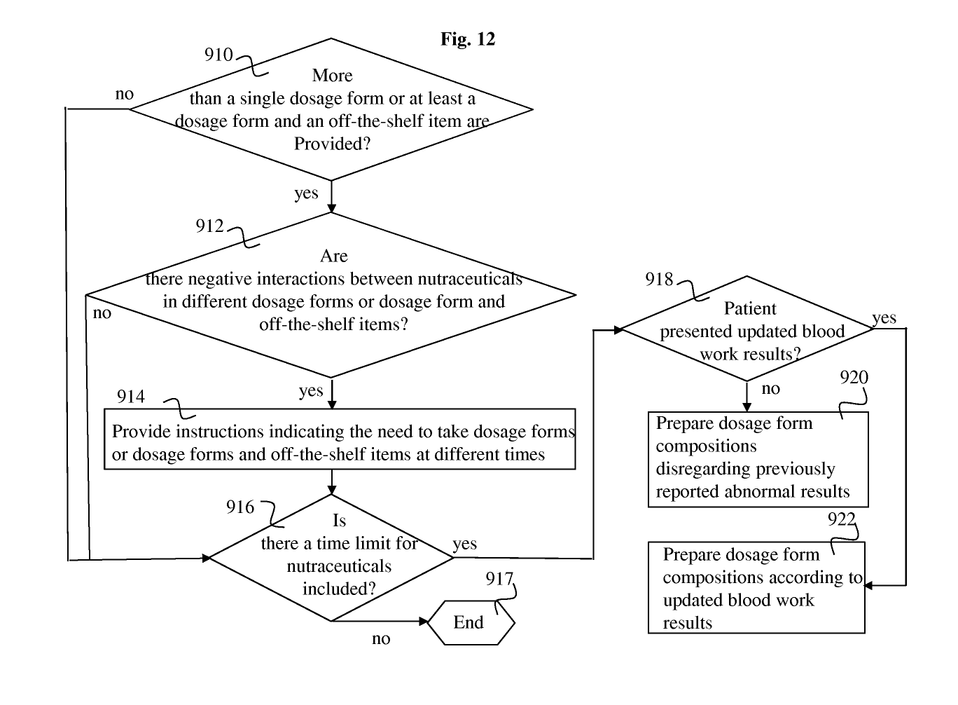

According to a specific embodiment, illustrated in FIG. 12, instructions are provided in the case of providing more than a single dosage form according to the following guidelines:

Check whether more than a single dosage form or at least a dosage form and an off-the-shelf item are provided (910); if yes, then check whether there are negative interactions between nutraceuticals in different dosage forms or dosage form and off-the-shelf items (912); if yes, provide instructions indicating the need to take dosage forms or dosage forms and off-the-shelf items at different times (914); and check whether there is a time limit for taking nutraceuticals included in dosage forms (916); if not, terminate the process (917), and if yes, check whether patient presented updated blood work results (918); if patient has not presented updated blood work, then prepare dosage form compositions disregarding previously reported abnormal results (920); if updated blood work has been provided, then prepare dosage form compositions according to updated blood work results (922).

If the answer at (910) or (912) is no, then go to (916).

The System

Reference is now made to FIG. 13, which is a block diagram showing a system (1100) for providing a personalized list of dietary nutraceuticals.

According to certain embodiments of the present invention, the system (1100) includes a processor (1110) and a database (1124). The database (1124) includes one or more lists of nutraceuticals including nutrients and supplements. Each nutraceutical in the database (1124) is associated with a plurality of recommended daily doses, each recommended daily dose is associated with different parameters such as age, weight, gender, activity level, and/or medical conditions of the individual, for example, or any other predefined parameters such as those discussed above. This data structure allows for calculating an individualized daily dose for each nutraceutical according to personal input data of the respective individual for generating the list of nutraceuticals including associated individualized daily doses.

The data structure of the database (1124) is such that at least some of the nutraceuticals in the database (1124) list are each associated with one or more interaction values, thereby defining interrelations between nutraceuticals, indicating affected and affecting nutraceuticals and the manner and extent to which they influence the bioavailability of each other, as explained in more detail above.

In some embodiments, the database includes additional information, for example, tables including associations between certain nutraceuticals and individual parameters such as, e.g. medical conditions or physical activity. In some embodiments, the information is provided through a graphic user interface (GUI) which is described below. In some embodiments, the system can retrieve such information via an internet connection. In some embodiments, the information is accessible via an internet connection and is constantly updated. In some embodiments, the information is updated periodically.

The processor (1110) is configured to generate a personalized list of nutraceuticals tailored for the specific individual, each nutraceutical in the list being associated with an individualized daily dose. According to some embodiments of the invention, the processor (1110) includes: (i) a parameter receiving module (1112) for receiving parameters related to the individual such as his/her age, gender, level of physical activity, etc.; (ii) a nutraceuticals module (1114) for generating a personalized list of nutraceuticals to be taken by the individual comprising nutrients, where the list is generated according to the parameters received, wherein each of the nutrients is associated with an individualized daily dose defined at least according to the parameters received; (iii) an identifying module (1116) for identifying in the personalized list at least one affected nutraceutical; (iv) an adjusting module (1118) for adjusting the list by adjusting the individualized daily dose associated with at least one of the identified affected nutraceutical according to the interaction value using a bioavailability adjustment algorithm, thereby generating a list of nutraceuticals and their associated individualized daily doses; and (v) an outputting module (1120) for outputting the list.

According to some embodiments, the processor (1110) further determines how the nutraceuticals in the list and combinations thereof are to be mixed and produced for consumption by the respective individual, outputting machine-readable instructions for preparing dosage forms accordingly.

It is appreciated that the modules comprised in the processor can be further configured to perform functions described above with reference to the methods provided by the invention.

According to certain embodiments, the adjusting module is configured for dividing said individualized daily dose by an interaction value associated with the at least one affecting nutraceutical and the identified affected nutraceutical when the at least one affecting nutraceutical is a sole affecting nutraceutical; and dividing the individualized daily dose by an integrated interaction value calculated from the interaction values associated with each one of the identified affected nutraceutical and each of the at least one affecting nutraceutical when the at least one affecting nutraceutical comprises more than one affecting nutraceutical.

According to certain embodiments, the system further comprises a dosage form module configured for (i) calculating a diluted amount for at least one nutraceutical comprised in the list based at least on the individualized daily dose thereof and a predetermined dilution factor; (ii) determining a number of dosage forms required per day according to dosage form number determining factors; and (iii) assigning the nutraceuticals to a dosage form according to a dosage form assignment algorithm.

According to some embodiments, the processor operates a specially designed graphical user interface (GUI) for allowing input of external data. In some embodiments the GUI is used to allow a user to input personal data such as age, gender, medical conditions or schedule of exercise, etc., according to which the list is generated. In some embodiments, the GUI is used to input other external data, e.g., associations between parameters and certain nutraceuticals.

According to some embodiments, the system provides a website having a special GUI, through which a large number of users can input personal data, where the system generates one or more personalized lists for each respective user according to his/her personal data. The system and GUI thereof may further support a delivery service in which once the personalized list of the respective user is generated and presented to the user, the website offers delivering the nutraceuticals according to the list via a designated purchasing interface thereof

According to certain embodiments, the database also includes the items described below.

Each nutraceutical can additionally be associated with optional various features such as substitute materials which can be used instead of certain nutraceuticals, percent of absorbance, its level of importance, its availability as a shelf item.

According to some embodiments, the database can include additional items. For example, food products (tomato, salt, soup, lentils, etc.). The food products are grouped into groups and subgroups of food products. For example, the first level are groups of food products such as: dairy, fish, meet, candy, beverages, etc. and the second includes subgroups of the food products in the first group, e.g., the dairy products group includes as subgroups white cheeses, yellow cheeses, etc. More than two levels can also be defined, as needed. Each product belongs to at least one subgroup at the lowest level, which defines its association with higher groups. Any product can be part of more than a single group.

“Generic products” are defined as food products having average values and representing a group of products, e.g., “poultry products and chicken patties”, with values that are in fact an average of poultry products in general.

The database further includes measuring units, such as a teaspoon, a spoon, a sup, a medium size plate, etc. Each food product is associated with the appropriate measuring units, for example white cheese is associated with a spoon, a teaspoon, a small plate. Each measuring unit is associated with its weight value, e.g., a teaspoon=3 grams. The databases includes for each item the weight of the relevant measuring units, for example, tomato or carrot are both associated with a “unit”, while the weight of a unit of carrots (a single carrot) is different from a weight of a unit of tomatoes (one tomato). For items of the “generic products” group, for example, it may be possible to only define weight in grams, since it is not possible to define general units for products having different measures.

Each food product is associated with all its nutrients and supplements content per 100 grams, divided into three groups: macro-nutrients, micro-nutrients (Table 7) and supplements. In addition, each food product is associated with its cholesterol, alcohol, trans fatty acids and sugars content. Macro-nutrients exist in four types: fat, saturated fat (a component of fat), protein and carbohydrates

TABLE 7
Examples for micro-nutrients

| Micro-nutrient | OEM | Dilution |
|---|---|---|
| Calcium | 2 | 0.36 |
| Iron | 0 | 0.2 |
| Magnesium | 0 | 0.585 |
| Selenium | 0 | 0.015 |
| Zinc | 0 | 0.11 |
| Copper | 0 | 0.127 |
| Folate | 0 | 0.905 |
| Vitamin A | 0 | 0.128 |
| Vitamin E | 0 | 0.5 |
| Vitamin C | 0 | 0.99 |
| Chromium | 0 | 0.115 |
| Vitamin D | 0 | 0.0025 |

OEM—original equipment manufacturer;
OEM = 0 indicates that the nutrient is not available as a separate off-the-shelf item;
OEM = 2 indicates that the micro-nutrient is available both as an off-the-shelf item or as part of a mixture;
dilution—the fraction of active ingredient in the supplied mixture.

Every food item is associated with “Retention Factors” for different methods of preparation, such as baking, cooking, roasting, etc. These are percentage values which define the amounts of micro-nutrients preserved following preparation by a certain method. For example, the item “orange” can be associated with an amount of 3 grams (per 100 grams) of the nutrient “vitamin C”. For the preparation method “baking” vitamin C in an orange can have a Retention Factor of 0.9, meaning that a baked orange has 2.7 (3×0.9) grams of vitamin C. Each nutrient (e.g., Zinc) will have a different Retention Factor for the same item “orange” and the same preparation method “baking”. In cases where a Retention Factor is not defined, the default is 1.

Each item is also associated with relevant allergies or sensitivities.

The database enables keeping and saving recipes, which are lists of the food products which make up the recipe, including amounts and methods of preparation. Adding a recipe to the database requires adding each food product together with the amount needed for the recipe and the relevant method of preparation. The recipe will receive a name and can be associated with relevant consumption units. Its total weight will be the sum of the weights of the products included in the recipe. For example, a fruit cake recipe can be associated with a consumption unit “slice” and the weight of a slice can be determined by two methods: either directly (e.g., 80 grams) or define that the recipe includes eight units of the type “slice” and then if the cake weight 800 grams, then each slice weighs 100 grams.

D is the caloric consumption of the subject and is calculated from the daily menu for all food products, based on the amounts of fat, protein and carbohydrates. This amount is calculated by multiplying the amounts of fat, proteins and carbohydrates per 100 grams of food product by the amount consumed and adding the results for all food product consumed on the same day.

A dietician will be able to access and correct a menu which has been entered by a subject. For example, the dietician can add or delete food products to/from a daily menus or change amounts of food products in daily menus. Adding food products can also be done for average menus, and the added product is then added to all the specific daily menus.

According to the second method, the dietician assembles a daily menu based on the dietary habits of the subject, which are obtained by questioning the subject. The dietician enters food products and corresponding amounts to build a daily menu. The daily menu will be the basis for calculating gaps between nutraceuticals consumed amounts and recommended daily doses.

According to certain embodiments, some of the questions for information retrieval are only asked at the first instance of information retrieval by filling the questionnaire and cannot be updated. Such questions relate, for example, to chronic medical conditions, family history, operations, etc.

Before placing a new order for dietary nutraceuticals, the subject will be asked questions related to, for example, a change in life style, such as changes in physical activity, work or smoking. Such questions can be answered directly by the subject, and the content of the dietary nutraceuticals can be updated, as necessary, in accordance with the new input.

Some changes require an interview with a representative, such as the dietician, if a representative was involved in the initial registration process. Subjects who registered without a representative will update by themselves. Such questions relate, for example, to changes in certain medical conditions, changes in diet and beginning or stopping taking medications.

Manufacturing Options

According to certain embodiments, some manufacturing options for dosage forms are described below.

According to a specific embodiment, all nutraceuticals to be mixed into the same dosage form are added together in the same device by the same collecting device, according to the number of days defined by the batch value and the number of extra dosage forms defined for quality control. The total “virtual” number of days in a tray are herein termed “Final Batch”. For example, in the case of a tray with a capacity of 200 dosage forms and Batch=90, the number of dosage forms per day is 2, as explained above. Since there is an excess of 20 dosage forms in the tray, there is a “virtual” excess of 10 days (2 dosage forms per day), and therefore the Final Batch=100, out of which only 90 days will be packed for delivery to the subject.

The minimal amount in milligrams of a single nutraceutical, which can be taken by the assembly line is herein termed “Fetch”. There can be more than one Fetch value, for example—“Fetch spoon” or “Fetch caplet”, depending on the process. For example, if Fetch Caplet=20 for iron, then it is impossible for the assembly line to take less than 20 milligrams.

In case the amount of a nutraceutical required, for example, for a tray of dosage forms, is not divisible by the Fetch value without remainder, then a threshold value will define the limit up to which the amount will be rounded downward and below which the amount will be rounded upward.

For example, the Fetch value for calcium is 20 mg and the threshold value is 12 mg. If the daily required dose of calcium for adding to the dosage form is 83.46 mg, the amount for adding for a tray is multiplied by Final Batch=83.46* 100=8346. The closest value of an integer multiplied by 20 mg is 8340 and the difference is 6 mg, which is less than the threshold value of 12 mg. The required amount of calcium will therefore be 8340 mg.

According to another example, if the daily required amount is 83.55, and the total required amount is 83.55*100=8355 mg, then the difference from 8340 is 15 mg and the required amount will be 8360 mg.

In the case of rounding upward, if the required dose of the nutraceutical was calculated based on a gap between daily intake and DRI values, the new value (divided by the Final Batch value) must be compared to maximal DRI value so as not to exceed it. If a maximal value is exceeded, then the amount to be used is rounded downward instead of upward. This check against DRI values will not be done for nutrients for which the individualized daily dose has been adjusted as a result of a medical condition, which are usually higher than DRI values. However, if a medical condition exists that is associated with a maximal value for the nutrient used, the rounded amount must be compared to the maximal value as explained above with reference to DRI maximal values.

Additionally, nutraceuticals assigned OEM=1, meaning that they are only available as off-the-shelf items, do not have an associated Fetch value.

An additional value indicates whether to use the value in Fetch caplet or in Fetch spoon. A different threshold variable for upward or downward rounding is defined for each case.

1. A method for providing a personalized list of dietary nutraceuticals to an individual, wherein at least one of the nutraceuticals affects the bioavailability of at least one other of the nutraceuticals, the method comprising the steps of:
(i) receiving parameters related to said individual;
(ii) generating a list of nutraceuticals to be taken by said individual comprising nutrients, said list being generated according to said parameters received, wherein each of said nutrients is associated with an individualized daily dose defined at least according to said parameters received;
(iii) identifying in said list at least one affected nutraceutical, the bioavailability of which being influenced by at least one affecting nutraceutical comprised in said list, wherein the influence of each of said at least one affecting nutraceutical on said at least one affected nutraceutical is independently represented by a respective interaction value;
(iv) adjusting the individualized daily dose associated with at least one of said affected nutraceutical identified in step (iii) according to at least one of said respective interaction values, using a bioavailability adjustment algorithm; and
(v) outputting said list of nutraceuticals with their associated individualized daily doses.

2. (canceled)

3. The method of claim 1, wherein parameters received in step (i) comprise a daily diet, and said individualized daily dose defined in step (ii) of claim 1 for each one of said nutrients is calculated by subtracting from the daily dose recommended for said nutrient according to Dietary Reference Intake (DRI) tables an estimated daily intake calculated based at least on said daily diet.

4. The method of claim 1, further comprising prior to step (iii):
(a) identifying at least one of said parameters received which is associated with a minimal or maximal daily dose value for at least one of the nutrients comprised in said list, and adjusting said individualized daily dose associated with said at least one nutrient according to a dose defining algorithm, wherein said individualized daily dose of said at least one nutrient is not further adjusted according to step (iv); and/or
(b) identifying at least one of said parameters received which is associated with a minimal or maximal daily dose value for at least one dietary supplement, and adding each one of said at least one dietary supplement to said list of nutraceuticals, wherein for each one of said at least one dietary supplement, an individualized daily dose is calculated according to a dose defining algorithm.

5. (canceled)

6. The method of claim 4, wherein said dose defining algorithm for each one of said at least one nutrient or each one of said at least one dietary supplement comprises:
(i) reviewing the minimal or maximal daily dose value associated with each of said at least one parameter identified and said nutrient or supplement; and
(ii) defining said individualized daily dose for said nutrient or said supplement as:
a) the highest of said minimal daily dose values when said minimal or maximal daily dose values comprise only minimal daily dose values;
b) the lowest of said maximal daily dose values when said minimal or maximal daily dose values comprise only maximal daily dose values; or
c) the lower between the highest minimal daily dose value and the lowest maximal daily dose value when said minimal or maximal daily dose values comprise at least one minimal daily dose value and at least one maximal daily dose value.

7. (canceled)

8. The method of claim 1, wherein said adjusting the individualized daily dose associated with at least one of said affected nutraceutical in step (iv) comprises:
(i) dividing said individualized daily dose by an interaction value associated with said at least one affecting nutraceutical and said affected nutraceutical when said at least one affecting nutraceutical is a sole affecting nutraceutical; or
(ii) dividing said individualized daily dose by an integrated interaction value calculated from the interaction values associated with each one of said affected nutraceutical and each of said at least one affecting nutraceutical when said at least one affecting nutraceutical comprises more than one affecting nutraceutical.

9. The method of claim 8, wherein said at least one affecting nutraceutical comprises more than one affecting nutraceuticals, and:
(i) all of said interaction values are above a predefined neutral interaction value, and said integrated interaction value is the highest of said interaction values;
(ii) all of said interaction values are below a predefined neutral interaction value, and said integrated interaction value is the lowest of said interaction values; or
(iii) some of said interaction values are above and some of said interaction values are below a predefined neutral interaction value, and said integrated interaction value reflects the combination of the highest of the interaction values above said predefined neutral interaction value and the lowest of the interaction values below said predefined neutral interaction value.

10. The method of claim 8, wherein said at least one affecting nutraceutical comprises more than one affecting nutraceuticals, and said integrated interaction value is calculated by multiplying all of the interaction values associated with said affected nutraceutical and each of said at least one affecting nutraceutical.

11. The method of claim 8, wherein said at least one affecting nutraceutical comprises more than one affecting nutraceuticals, and said integrated interaction value is calculated according to the following steps:
(i) defining for each of said at least one affecting nutraceutical a synergy portion and adjusting the interaction value associated with said affecting nutraceutical and said affected nutraceutical if the individualized daily dose for said affecting nutraceutical is less than said synergy portion, to reflect the ratio between said individualized daily dose and said synergy portion;
(ii) defining said integrated interaction value as the highest of said interaction values, wherein the interaction values for each of said at least one affecting nutraceutical are above a predefined neutral interaction value;
(iii) defining said integrated interaction value as the lowest of said interaction values wherein the interaction values for each of said at least one affecting nutraceutical are below a predefined neutral interaction value; and
(iv) offsetting the values above the predefined neutral interaction value with the values below said predefined neutral interaction value to until only interaction values above or only interaction values below said predefined neutral interaction value are left, wherein some of said interaction values are above and some of said interaction values are below said predefined neutral interaction value, and defining the integrated interaction value is as in (ii) or (iii).

12. The method of claim 1, further comprising preparing at least one dosage form including the nutraceuticals comprised in said list, each of said nutraceuticals being in an amount based on its associated individualized daily value.

13. The method of claim 12, wherein preparing said at least one dosage form comprises the steps of:
(i) calculating a diluted amount for at least one nutraceutical comprised in said list based at least on the individualized daily dose thereof and a predetermined dilution factor;
(ii) determining the number of said at least one dosage form needed for packaging all nutraceuticals on said list according to dosage form number determining factors;
(iii) assigning said nutraceuticals to said at least one dosage form, the number of which determined in step (ii), according to a dosage form assignment algorithm; and
(iv) for each one of said at least one dosage form, mixing together nutraceuticals assigned to said dosage form according to their respective diluted amount to thereby prepare said individual dietary nutraceuticals.

14. The method of claim 13, wherein calculating a diluted amount for at least one nutraceutical comprised in said list is done by dividing the individualized daily dose of said nutraceutical by a predetermined dilution factor assigned to said nutraceutical.

15. The method of claim 13, wherein said dosage form number determining factors are selected from:
a) the presence of at least one nutraceutical of said list that abolishes the bioavailability of at least one other nutraceutical of said list;
b) the presence of at least one nutraceutical of said list, the individualized daily dose of which is divided into more than one daily intake;
c) the total amount of all nutraceuticals comprised in said list exceeds the capacity of the largest dosage form available; and
d) the presence of nutraceuticals comprised in said list which cannot be mixed together because of technical considerations.

16. The method of claim 1, wherein at least one of said nutraceuticals comprised in said list is not mixed with other nutraceuticals comprised in said list and is provided as an off-the-shelf item.

17. The method of claim 13, wherein said dosage form assignment algorithm comprises assigning nutraceuticals to different dosage forms when one nutraceutical has a negative effect on the bioavailability of a second nutraceutical; and assigning nutraceuticals to the same dosage form when one nutraceutical has a positive effect on the bioavailability of a second nutraceutical.

18. The method of claim 13, wherein said diluted amount for each one of said nutraceuticals assigned to each one of said dosage forms is revised based on positive or negative effects on the bioavailability of said nutraceutical by other nutraceuticals assigned to said dosage form.

19. The method of claim 13, wherein step (iv) further comprises mixing a pharmaceutically acceptable carrier together with nutraceuticals assigned to at least one of said dosage forms.

20-21. (canceled)

22. A computerized system for providing a personalized list of dietary nutraceuticals to an individual, wherein at least one of the nutraceuticals affects the bioavailability of at least one other of the nutraceuticals, the system comprising:
(i) a parameter receiving module for receiving parameters related to said individual;
(ii) a nutraceuticals module for generating a list of nutraceuticals to be taken by said individual comprising nutrients, said list being generated according to said parameters received, wherein each of said nutrients is associated with an individualized daily dose defined at least according to said parameters received;
(iii) an identifying module for identifying in said list at least one affected nutraceutical, the bioavailability of which being influenced by at least one affecting nutraceutical comprised in said list, wherein the influence of each of said at least one affecting nutraceutical on said at least one affected nutraceutical is independently represented by a respective interaction value;
(iv) an adjusting module for adjusting the individualized daily dose associated with at least one of said affected nutraceutical identified in step (iii) according to at least one of said respective interaction values, using a bioavailability adjustment algorithm; and
(v) an outputting module for outputting said list of nutraceuticals with their associated individualized daily doses.

23. The computerized system of claim 22, wherein said adjusting module is configured for:
(i) dividing said individualized daily dose by an interaction value associated with said at least one affecting nutraceutical and said affected nutraceutical when said at least one affecting nutraceutical is a sole affecting nutraceutical; and
(ii) dividing said individualized daily dose by an integrated interaction value calculated from the interaction values associated with each one of said affected nutraceutical and each of said at least one affecting nutraceutical when said at least one affecting nutraceutical comprises more than one affecting nutraceutical.

24. The computerized system of claim 22, further comprising a dosage form module configured for:
(i) calculating a diluted amount for at least one nutraceutical comprised in said list based at least on the individualized daily dose thereof and a predetermined dilution factor;
(ii) determining the number of dosage forms needed for packaging all nutraceuticals on said list according to dosage form number determining factors; and
(iii) assigning said nutraceuticals to said dosage forms according to a dosage form assignment algorithm.

25. A system for providing a personalized list of dietary nutraceuticals to an individual, wherein at least one of the nutraceuticals affects the bioavailability of at least one other of the nutraceuticals, the system comprising:
a) database comprising nutraceuticals and interrelations therebetween, said interrelations include affected and affecting properties of each nutraceutical and its associated interaction values representing the influence of said nutraceutical on an affected nutraceutical and/or the influence of an affecting nutraceutical on said nutraceutical; and
b) one or more processor configured for:
(i) receiving parameters related to said individual;
(ii) generating a list of nutraceuticals to be taken by said individual comprising nutrients, said list being generated according to said parameters received, wherein each of said nutrients is associated with an individualized daily dose defined at least according to said parameters received;
(iii) identifying in said list at least one affected nutraceutical, the bioavailability of which being influenced by at least one affecting nutraceutical comprised in said list, wherein the influence of each of said at least one affecting nutraceutical on said at least one affected nutraceutical is independently represented by a respective interaction value;
(iv) adjusting the individualized daily dose associated with at least one of said affected nutraceutical identified in step (iii) according to at least one of said respective interaction values, using a bioavailability adjustment algorithm; and
(v) outputting said list of nutraceuticals with their associated individualized daily doses.
